(19) United States
(12) Patent Application Publication
(10) Pub. No.: US 2024/0407033 A1
(43) Pub. Date: Dec. 5, 2024

(54) EARLY REAL-TIME RADIO LINK PROBLEM DETECTION

(71) Applicant: GOOGLE LLC, Mountain View, CA (US)

(72) Inventors: Rukun Mao, Santa Clara, CA (US); Xiantao Sun, Cupertino, CA (US); Qin Zhang, Mountain View, CA (US); Xu Ou, San Jose, CA (US); Mahesh Devdatta Telang, San Jose, CA (US); Yirong Chen, New Taipei City (TW)

(21) Appl. No.: 18/690,055

(22) PCT Filed: Sep. 8, 2021
(86) PCT No.: PCT/US2021/049471

§ 371 Date: Mar. 7, 2024

(51) Int. Cl. H04W 76/19; H04W 24/08

(52) U.S. Cl. CPC H04W 76/19; H04W 24/08

(57) ABSTRACT

A component of a cellular user equipment (UE) device is configured to detect adverse radio link conditions. The component monitors a plurality of layers of a communication stack of the UE device during an active voice call. Responsive to monitoring the plurality of layers, the component detects at least one adverse radio link condition associated with the active voice call. The component provides a radio link degradation indication to a second component of the UE device in response to detecting the at least one adverse radio link condition.

### BACKGROUND

Communication link failures can occur in cellular-based networks for various reasons, such as signal or transmission power issues, internal errors, and so on. When a radio link fails or becomes disconnected during an active voice call, a delay may occur between the link failure and realization of the failure by applications of the wireless communication device. The delay is typically caused by independent components of different communication stack layers detecting the link failure, which, in some instances, inhibits the wireless communication device from recovering the voice call or results in a poor user experience, such as a no connection situation.

### SUMMARY OF EMBODIMENTS

In accordance with one aspect, a method, performed at a first component of a cellular user equipment (UE) device for detecting adverse radio link conditions, includes monitoring a plurality of layers of a communication stack of the UE device during an active voice call. Responsive to monitoring the plurality of layers, at least one adverse radio link condition associated with the active voice call is detected. A radio link degradation (RLD) is provided to a second component of the UE device in response to detecting the at least one adverse radio link condition.

In at least some embodiments, monitoring the plurality of layers of the communication stack of the UE device during the active voice call comprises monitoring at least one parameter across one or more of the plurality of layers, the at least one parameter associated with maintenance of the active voice call. The at least one adverse radio link condition associated with the active voice call can be detected based on the at least one monitored parameter. In some examples, the at least one adverse radio link condition can be detected based on (or responsive to) the at least one monitored parameter satisfying one or more predetermined criteria. The criteria can be indicative of a quality of the active voice call.

Optionally, in some example embodiments, monitoring at least one parameter across one or more of the plurality of layers comprises monitoring a plurality of parameters across the plurality of layers, the plurality of parameters associated with maintenance of the active voice call. The at least one adverse radio link condition associated with the active voice call can be detected based on one or more of the monitored plurality of parameters. In some examples, the at least one adverse radio link condition can be detected based on (or responsive to) one or more of the monitored plurality of parameters satisfying one or more predetermined criteria. The criteria can be indicative of a quality of the active voice call.

In at least some embodiments, the RLD indication notifies the second component that the at least one adverse radio link condition exists and identifies a cause of the at least one adverse radio link condition. Providing the RLD indication, in at least some embodiments, includes providing the RLD indication to the second component during the active voice call.

In at least some embodiments, detecting the at least one adverse radio link condition includes detecting a signal strength update responsive to monitoring the plurality of layers. The signal strength update is one example of a monitored parameter. Responsive to detecting the signal strength update, one or more signal-related characteristics associated with the signal strength update are accessed. A determination is made whether a value associated with any of the one or more signal-related characteristics satisfies a corresponding threshold. Responsive to the value associated with any of the one or more signal-related characteristics satisfying the corresponding threshold, a determination is made that the at least one adverse radio link condition exists.

In at least some embodiments, the method further includes determining if transmission time interval (TTI) bundling is enabled at the UE device. Responsive to TTI bundling being enabled, the corresponding threshold is selected from a first set of thresholds. Responsive to TTI bundling being disabled, the corresponding threshold is selected from a second set of thresholds. The second set of thresholds is set lower than the first set of thresholds.

In at least some embodiments, the detected at least one adverse radio link condition is an out-of-sync condition and providing the RLD indication includes determining that a radio link failure (RLF) timer has been initiated in response to the out-of-sync condition occurring. The out-of-sync condition is one example of a monitored parameter. The RLD indication is provided to the second component upon initiation of the RLF timer and prior to the RLF timer expiring.

In at least some embodiments, the method further includes resetting an RLD indication that is internally maintained by the first component responsive to detecting one of the following: an in-sync condition having occurred while the RLF timer is active, the RLF timer having expired, or the RLF timer having expired and the UE device having successfully performed a radio resource control (RRC) connection re-establishment procedure.

In at least some embodiments, the detected at least one adverse radio link condition is an out-of-sync condition. The method further includes determining that an RLF timer has expired and the RLF timer has been initiated in response to the out-of-sync condition (903) occurring. Responsive to the RLF timer having expired, determining that the UE device has successfully performed an RRC connection re-establishment procedure. Responsive to the successful RRC connection re-establishment procedure, resetting an RLD indication internally maintained by the first component.

In at least some embodiments, the detected at least one adverse radio link condition is a radio link control (RLC) maximum retransmission condition associated with data traffic, and providing the RLD indication includes determining that the RLC maximum retransmission condition resulted in an RLF. The RLC maximum retransmission condition is an example of a monitored parameter. Responsive to the RLF, the RLD indication is provided to the second component. In at least some embodiments, a determination is made that the UE device has successfully completed an RRC connection re-establishment procedure in response to the RLF. Responsive to the successful completion of the RRC connection re-establishment procedure, a determination is made if any other adverse radio link conditions exist. Responsive to at least one other adverse radio link condition, an updated RLD indication is provided to the second component indicating that the least one other adverse radio link condition exists and that the RLC maximum retransmission condition no longer exists. Responsive to no other adverse radio link conditions existing, an RLD indication internally maintained by the first component is reset.

In at least some embodiments, detecting the at least one adverse radio link condition includes determining a required bandwidth at a first layer of the plurality of layers for current voice traffic on a downlink channel associated with the active voice call. A current throughput at a second layer of the plurality of layers is determined. The current throughput is for a dedicated voice radio bearer associated with the active voice call. Responsive to the required bandwidth being greater than the current throughput, a determination is made that a low capability condition exists at the first layer. The low capability condition is an example of a monitored parameter. In at least some embodiments, detecting the at least one adverse radio link condition further includes incrementing a low capability count responsive to determining that a low capability condition exists. The low capability count is compared to a low capability count threshold. The RLD indication is provided to the second component responsive to the low capability count satisfying the low capability count threshold. In at least some embodiments, an RLD indication internally maintained by the first component indicating the at least one adverse radio link condition exists is reset responsive to the low capability count failing to satisfy the low capability count threshold.

In at least some embodiments, detecting the at least one adverse radio link condition includes determining a required bandwidth for outgoing voice traffic associated with the active voice call at a first layer of the plurality of layers. A currently achieved throughput at a second layer of the plurality of layers on an uplink channel associated with the active voice call is determined. A determination is made that a low capability condition exists at the second layer responsive to the required bandwidth being greater than the currently achieved throughput.

In at least some embodiments, detecting the at least one adverse radio link condition further includes incrementing a low capability count responsive to determining that a low capability condition exists. The low capability count is compared to a low capability count threshold. The RLD indication is provided to the second component responsive to the low capability count satisfying the low capability count threshold. In at least some embodiments, an RLD indication internally maintained by the first component and indicating the at least one adverse radio link condition exists is reset responsive to the low capability count failing to satisfy the low capability count threshold.

In at least one embodiment, detecting the at least one adverse radio link condition includes determining that a high transmission power deficit condition exists. The high transmission power deficit condition is one example of a monitored parameter. A determination is made that a throughput of outgoing voice packets at a first layer of the plurality of layers is less than a throughput of voice traffic generated at a second layer of the plurality of layers. In at least some embodiments, determining that a high transmission power deficit condition exists includes detecting a transmission power deficit and comparing the transmission power deficit to a transmission power deficit threshold. A high transmission power deficit count is incremented responsive to the transmission power deficit satisfying the transmission power deficit threshold incremented. A ratio of high transmission power deficit instances, for a monitoring window of a given number of transmission instances, is determined based on the high transmission power deficit count. A determination is made that the high transmission power deficit condition exists responsive to the ratio of high transmission power deficit instances satisfying a ratio threshold.

In accordance with another aspect, a user equipment device includes one or more radio frequency (RF) modems configured to wirelessly communicate with at least one network. One or more processors are coupled to the one or more RF modems. At least one memory stores executable instructions. The executable instructions are configured to manipulate at least one of the one or more processors or the one or more RF modems to perform any of the method operations described herein.

In accordance with yet another aspect, a computer-readable storage medium embodies a set of executable instructions. The set of executable instructions is to manipulate a computer system to perform any of the method operations described herein.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

The present disclosure may be better understood, and its numerous features and advantages made apparent to those skilled in the art by referencing the accompanying drawings. The use of the same reference symbols in different drawings indicates similar or identical items.

FIG. 1 is a diagram illustrating an example wireless communication system employing a user equipment (UE) device implementing one or more detection mechanisms for adverse radio link conditions in accordance with some embodiments.

FIG. 2 is a block diagram illustrating example modes of a detection mechanism for adverse radio link conditions employed by the UE device of FIG. 1 in accordance with some embodiments.

FIG. 3 is a diagram illustrating an example configuration of a UE device implementing one or more detection mechanisms for adverse radio link conditions in accordance with some embodiments.

FIG. 4 is a diagram illustrating an example configuration of a system-on-chip (SoC) implementing one or more detection mechanisms for adverse radio link conditions in accordance with some embodiments.

FIG. 5 is a diagram illustrating an example configuration of a communication processor implementing one or more detection mechanisms for adverse radio link conditions in accordance with some embodiments.

FIG. 6 is a diagram illustrating an example functional configuration of a communication processor implementing one or more detection mechanisms for adverse radio link conditions in accordance with some embodiments.

FIG. 7 and FIG. 8 together illustrate a diagram of an example operation of implementing adverse radio link condition detection at a UE device based on low signal strength in accordance with some embodiments.

FIG. 9 is a diagram illustrating an example operation of implementing adverse radio link condition detection at a UE device based on out-of-sync induced radio link failures in accordance with some embodiments.

FIG. 10 is a diagram illustrating an example operation of implementing adverse radio link condition detection at a UE device based on maximum retransmission induced radio link failures in accordance with some embodiments.

FIG. 11 is a diagram illustrating an example operation of implementing adverse radio link condition detection at a UE device based on low physical layer capability on the downlink channel in accordance with some embodiments.

FIG. 12 is a diagram illustrating an example operation of implementing adverse radio link condition detection at a UE device based on low physical layer capability on the uplink channel in accordance with some embodiments.

FIG. 13 is a diagram illustrating an example operation of implementing adverse radio link condition detection at a UE device based on transmission power deficit in accordance with some embodiments.

### DETAILED DESCRIPTION

Components within a user equipment (UE) device typically share limited radio link information. By limiting or delaying the sharing of radio link information, the components can save power, avoid unnecessary distractions to applications, and so on. However, limiting or delaying radio link information associated with an active voice call can lead to various operational and user experience issues. For example, if a component, such as an application processor, receives delayed or limited information regarding an adverse radio link for an active voice call, the application processor may miss the opportunity to save the call by taking appropriate action, such as switching to voice over wireless-fidelity (VoWiFi). Also, the UE device may unnecessarily use computational resources by leaving the call open and having the user interface of the UE device show that the call is connected even though the radio link has failed, which results in a poor user experience.

As such, the following describes embodiments of systems and methods for configuring at least one component of a UE device to actively detect and report adverse radio link conditions related to voice traffic in real-time. For example, a component of the UE device is configured to monitor, analyze, and report voice call-related information, such as radio link information that caused or can potentially cause a voice call to drop or experience low-quality audio. Examples of such radio link information include low signal, radio link failure (RLF), and so on. In at least some embodiments, the configured UE component collects information across various network protocol stack layers within, for example, the communication processor. The configured UE component monitors and processes key factors (or parameters) associated with maintaining a voice call connection with acceptable quality. For example, the UE component monitors one or more parameters across at least one network protocol stack layer, the one or more parameters associated with maintaining the active voice call (and in particular, associated with maintaining the active voice call with a quality above a quality threshold). By monitoring and analyzing the key factors across network protocol stack layers, the configured UE component is able to detect radio link issues in real-time or near real-time with improved accuracy over conventional radio link failure mechanisms. Upon detecting a radio link failure (or potential failure), the configured UE component notifies another UE component, such as the application processor, so that appropriate actions can be taken to mitigate operational and resource issues, and user experience issues, caused by the radio link failure or impending failure.

For ease of illustration, the following techniques are described in an example context in which one or more UE devices and radio access networks (RANs) implement one or more radio access technologies (RATs), including at least a Fifth Generation (5G) New Radio (NR) standard (e.g., Third Generation Partnership Project (3GPP) Release 15, 3GPP Release 16, etc.) (hereinafter, “5G NR” or “5G NR standard”). However, it should be understood that the present disclosure is not limited to networks employing a 5G NR RAT configuration, but rather the techniques described herein can be applied to any combination of different RATs employed at the UE devices and the RANs. It should also be understood that the present disclosure is not limited to any specific network configurations or architectures described herein for implementing radio link failure detection at the UE device. Instead, techniques described herein can be applied to any configuration of RANs. Also, the present disclosure is not limited to the examples and context described herein, but rather the techniques described herein can be applied to any network environment where a UE device implements detection techniques for adverse radio link conditions.

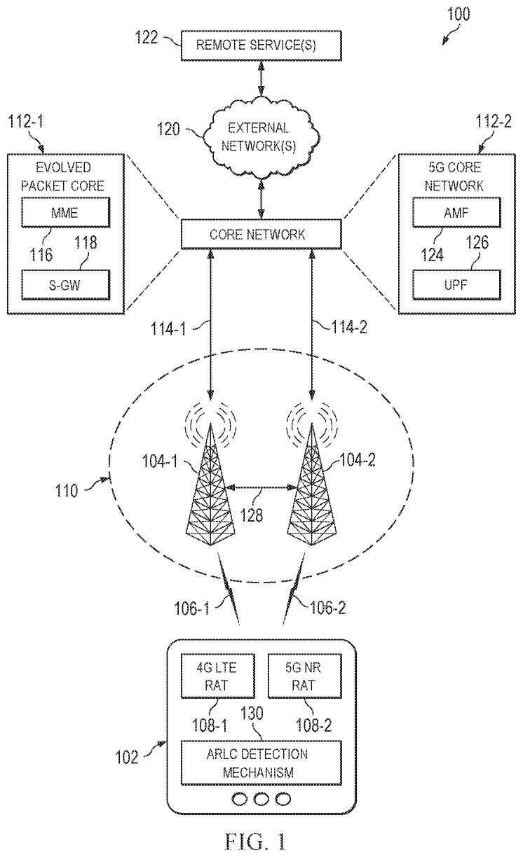

FIG. 1 illustrates a mobile cellular network (system) 100 in accordance with at least some embodiments. As shown, the mobile cellular network 100 includes a user equipment (UE) device 102 that is configured to communicate with one or more base stations 104 (base stations 104-1 and 104-2) through one or more wireless communication links 106 (wireless links 106-1 and 106-2). The UE device 102, in at least some embodiments, includes any of a variety of wireless communication devices, such as a cellular phone, a cellular-enabled tablet computer or cellular-enabled notebook computer, a cellular-enabled wearable device, an automobile, or other vehicle employing cellular services (e.g., for navigation, provision of entertainment services, in-vehicle mobile hotspots, etc.), and so on. In at least some embodiments, the UE device 102 employs a single RAT 108. In other embodiments, the UE device 102 is a multi-mode UE device that employs multiple RATs 108. Examples of multiple RATs include a 3GPP Long-Term Evolution (3GPP LTE) RAT 108-1 and a 3GPP Fifth Generation New Radio (5G NR) RAT 108-2.

In at least some embodiments, the base stations 104 are implemented in a macrocell, microcell, small cell, picocell, and the like, or any combination thereof. Examples of base stations 104 include an Evolved Universal Terrestrial Radio Access Network Node B (E-UTRAN Node B), Evolved Node B (eNodeB or eNB), Next Generation (NG or NGEN) Node B (gNode B or gNB), and so on. The base stations 104 communicate with the UE device 102 via the wireless links 106, which are implemented using any suitable type of wireless link. The wireless links 106, in at least some embodiments, include a downlink of data and control information communicated from the base stations 104 to the UE device 102, an uplink of data and control information communicated from the UE device 102 to the base stations 104, or both. The wireless links 106 (or bearers), in at least some embodiments, are implemented using any suitable communication protocol or standard, or combination of communication protocols or standards, such as 3GPP 4G LTE, 5G NR, and so on. In at least some embodiments, multiple wireless links 106 are aggregated in a carrier aggregation to provide a higher data rate for the UE device 102. Also, multiple wireless links 106 from multiple base stations 104 are configured, in at least some embodiments, for coordinated multipoint (COMP) communication with the UE device 102, as well as dual connectivity, such as single-RAT LTE-LTE or NR-NR dual connectivity, or multi-radio access technology (Multi-RAT) dual connectivity (MR-DC) including E-UTRA-NR dual connectivity (EN-DC), NGEN radio access network (RAN) E-UTRA-NR dual connectivity (NGEN-DC), and NR E-UTRA dual connectivity (NE-DC).

The base stations 104 collectively form a Radio Access Network 110, such as an E-UTRAN or 5G NR RAN. The base stations 104 are connected to a core network 112 via control-plane and user-plane interfaces through one or more links 114 (links 114-1 and 114-2). Depending on the configuration of the mobile cellular network 100, the core network 112 is either an Evolved Packet Core (EPC) network 112-1 or a 5G Core Network (5GC) 112-2. For example, in an E-UTRAN configuration or a 5G non-standalone (NSA) EN-DC configuration, the core network 112 is an EPC network 112-1 that includes, for example, a mobility management entity (MME) 116 and a serving gateway (S-GW) 118. The MME 116 provides control-plane functions, such as registration and authentication of multiple UE devices 102, authorization, mobility management, and so on. The S-GW 118 relays user-plane data between UE devices 102 and external networks 120 (e.g., the Internet) and one or more remote services 122. In a 5G standalone (SA) configuration or an NSA NE-DC or NGEN-DC configuration, the core network 112 is a 5GC network 112-2. The 5GC 112-2 includes, for example, an access and mobility management function (AMF) 124 and a user plane function (UPF) 126. The AMF 124 provides control-plane functions such as registration and authentication of multiple UEs 102, authorization, mobility management, and so on. The UPF 126 relays user-plane data between UEs 102 and external networks 120 (e.g., the Internet) and one or more remote services 122.

In at least some embodiments, when the UE device 102 uses EN-DC, the UE device 102 communicates with a first base station 104-1 implementing, for example, a 4G LTE RAT, which acts as a master node (MN), and the wireless link 106-1 is an E-UTRA link. The UE device 102 also communicates with a second base station 104-2 implementing, for example, a 5G NR RAT, which acts as a secondary node (SN), and the wireless link 106-2 is a 5G NR link. At link 128, the first base station (e.g., eNB) 104-1 and the second base station (e.g., 5G NR) 104-2 communicate user-plane and control-plane data via, for example, an X2 interface. The first base station 104-1 communicates control plane information with the MME 116 in the EPC 112-1 via, for example, an S1-MME interface and relays control-plane information to the second base station 104-2 via, for example, the X2 interface.

User plane (UP) data is transported between the EPC network 112-1 and the UE device 102 using data radio bearers (DRBs). Examples of DRBs in EN-DC include a master cell group (MCG) bearer, a secondary cell group (SCG) bearer, and a split-bearer. An MCG Bearer is a direct DRB that terminates at the MN (e.g., the first base station 104-1) and only uses the MN lower layers (radio link control (RLC), medium access Layer (MAC), and physical layer (PHY)). When an MCG Bearer is used, the MN receives data from the EPC network 112-1 and transmits the data to the UE device 102. An SCG bearer is a direct DRB that terminates at the SN (e.g., the second base station 104-2) and only uses the SN lower layers (RLC, MAC, and PHY).

When an SCG bearer is used, the SN receives data from the EPC network 112-1 and transmits the data to the UE device 102. A split-bearer is either an MCG split-bearer or an SCG split-bearer. An MCG split-bearer is a DRB that terminates at the MCG and uses either or both of the MN and SN lower layers. When an MCG split-bearer is used, the MN receives data from the EPC network 112-1 and splits the data into two parts. One part of the data is transmitted from the MN to the UE device 102, and the second part of the data is transmitted from the SN to the UE device 102. An SCG split-bearer is a DRB that terminates at the SN and uses either or both of the MN and SN lower layers. When an SCG split-bearer is used, the SN receives data from the EPC network 112-1 and splits the data into two parts. One part of the data is transmitted from the SN to the UE device 102, and the second part of the data is transmitted from the MN to the UE device 102.

In other embodiments, when the UE device 102 uses NGEN-DC, the UE device 102 communicates with the first base station 104-1, which acts as the MN, and the wireless link 106-1 is an E-UTRA link. The UE device 102 also communicates with the second base station 104-2, which acts as a SN, and the wireless link 106-2 is a 5G NR link. At link 128, the first base station 104-1 and the second base station 104-2 communicate user-plane and control-plane data via, for example, an Xn interface. The first base station 104-1 communicates control plane information with the AMF 124 in the 5GC network 112-2 via, for example, an NG-C interface and relays control-plane information to the second base station 104-2 via, for example, the Xn interface.

In further embodiments, when the UE device 102 uses NE-DC, the UE device 102 communicates with the second base station 104-2, which acts as the MN, and the wireless link 106-1 is a 5G NR link. The UE device 102 also communicates with the first base station 104-1, which acts as a SN, and the wireless link 106-1 is an E-UTRA link. At link 128, the first base station 104-1 and the second base station 104-2 communicate user-plane and control-plane data via, for example, the Xn interface. The second base station 104-2 communicates control plane information with the AMF 124 in the 5GC network 112-2 via, for example, the NG-C interface and relays control-plane information to the first base station 104-1 via, for example, the Xn interface.

Turning from an MR-DC configuration, the FIG. 1 environment, in at least some embodiments, represents a single-RAT DC configuration. In one type of single-RAT DC situation, both base stations 104-1 and 104-2 are E-UTRA base stations and communicate user-plane and control-plane data via, for example, an X2 interface over link 128, and both base stations 104-1 and 104-2 link to the EPC 112-1. In another type of single-RAT DC configuration, both base stations 104-1 and 104-2 are 5G NR base stations and communicate user-plane and control-plane data via, for example, an Xn interface over link 128, and both base stations 104-1 and 104-2 link to the 5GC network 112-2.

During operation of a voice call, the UE device 102 may experience adverse radio link conditions that result or may potentially result in a radio link failure or poor audio quality. The quality of the voice call may fall below a predetermined quality threshold due to the adverse radio link conditions, or may be dropped/lost completely from the UE device 102. Accordingly, in at least some embodiments, the UE device 102 employs one or more adverse radio link condition (ARLC) detection mechanisms 130 to detect adverse radio link conditions and radio link failures associated with an active voice call in or near real-time. As described in greater detail below, the ARLC detection mechanism(s) 130 includes one or more modes that actively detect (based on, for example, one or more monitored parameters associated with maintenance of the call) adverse radio link conditions related to voice traffic to provide real-time feedback regarding the cause of a radio link failure or a potential failure. In some examples, the at least one adverse radio link condition can be detected based on one or more of the monitored plurality of parameters satisfying one or more predetermined criteria, which can be indicative of (or associated with) a quality of the voice call. By monitoring radio link conditions and providing feedback in or near real-time, user experience during a voice call is improved. For example, providing timely insights into the connectivity of a voice call keeps a user informed of current link conditions and avoids frustrating scenarios for the user. Also, the various detection modes employed by the ARLC detection mechanism 130 provide early reporting of a radio link problem to one or more components of the UE device 102. Early reporting of adverse link conditions allows components of the UE device 102, such as an application processor, to take one or more actions, such as switching an active call to VoWiFi, to save the call. Resource use may therefore be improved.

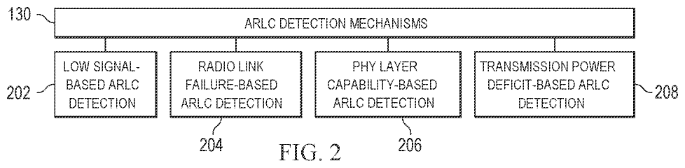

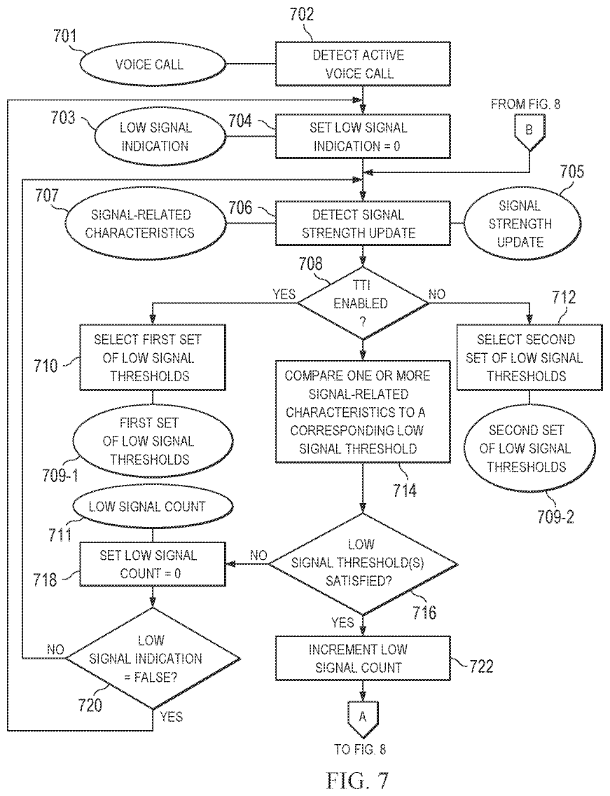

FIG. 2 illustrates various example modes employed singularly or in various combinations by the UE device 102 as part of the ARLC detection mechanism 130 in accordance with some embodiments. Each of these modes is discussed in greater detail below with respect to FIGS. 7 to 13. These modes may be provided individually, or one or more of the modes may be provided in any suitable combination as part of the ARLC detection mechanism 130.

One such mode includes a first ARLC detection mode 202. In this mode, the ARLC detection mechanism 130 monitors for a low signal condition by determining the signal strength of 4G LTE, 5G NR signals or beams, or a combination thereof based on one or more signal-related characteristics/parameters. Examples of signal-related characteristics include reference signal receive power (RSRP), reference signal received quality (RSRQ), carrier-to-interference-plus-noise ratio (CINR), signal-to-interference-plus-noise-ratio (SINR), and so on. The ARLC detection mechanism 130 determines that an adverse radio link condition exists during an active voice call when the signal strength associated with the call is below a threshold value. Stated differently, the ARLC detection mechanism 130, in this example, detects an adverse radio link condition based on the monitored parameter of the signal strength. In response, the ARLC detection mechanism 130 reports a radio link degradation (RLD) indication to inform one or more other components of the UE device 102 of the detected adverse radio link condition. In at least some embodiments, the likely cause of the RLD, such as a low signal condition, is also sent to the other component(s) of the UE device 102.

Another mode includes a second ARLC detection mode 204. In this mode, the ARLC detection mechanism 130 monitors for a radio link failure (RLF) due to an out-of-sync condition or a radio link control (RLC) maximum (max) retransmission condition. However, different from RLF due to out-of-sync or maximum retransmission defined in the 3GPP specifications, the second ARLC detection mode 204 of at least some embodiments provides flexibility in evaluating an RLD's impact on voice traffic and quality. Stated differently, the second ARLC detection mode 204, in at least some embodiments, is voice call oriented and the ARLC detection mechanism 130 reports RLD based on how RLD impacts a voice call. For example, during an active voice call, the ARLC detection mechanism 130 monitors for an out-of-sync indication generated by one or more protocol stack layers. In at least some embodiments, the ARLC detection mechanism 130 can monitor across the one or more (network) protocol stack layers for the generated out-of-sync indication/condition (or parameter). The out-of-sync indication, in at least some embodiments, identifies the number of intervals during which the UE device 102 was unable to successfully decode a physical downlink control channel (PDCCH). One example of an out-of-sync indication is an N310 indication defined in the 3GPP standards for 4G LTE and 5G NR. When a threshold number of consecutive out-of-sync indications has been detected, the ARLC detection mechanism 130 starts a timer, such as the network-configured T310 timer defined in the 3GPP standards for 4G LTE and 5G NR. If the timer expires or a threshold number of consecutive in-sync indications have not been received while the timer is running, the ARLC detection mechanism 130 determines that a radio link failure has occurred due to an out-of-sync condition. Stated differently, in this example, the ARLC detection mechanism 130 detects an adverse radio link condition based on the monitored parameter of the out-of-sync condition. One example of an in-synch indication is the N311 indication defined in the 3GPP standards for 4G LTE and 5G NR. In response, the ARLC detection mechanism 130 reports an RLD indication to inform one or more other components of the UE device 102 of the detected adverse radio link condition, such as a radio link failure. In at least some embodiments, the likely cause of the radio link failure, such as an out-of-sync condition, is also sent to other component(s) of the UE device 102.

When monitoring for an RLC maximum retransmission condition, the ARLC detection mechanism 130 monitors the number of RLC retransmission attempts during data traffic in an RLC acknowledged mode (AM). If the number of RLC retransmission attempts exceeds a threshold number, the ARLC detection mechanism 130 determines that an RLC maximum retransmission condition has occurred. The ARLC detection mechanism 130 sends an RLD indication to inform one or more other components of the UE device 102 of the detected adverse radio link condition, such as a radio link failure. In at least some embodiments, the likely cause of the radio link failure, such as an RLC maximum retransmission condition, is also sent to the other component(s) of the UE device 102.

Yet another mode includes a third ARLC detection mode 206, in which the ARLC detection mechanism 130 monitors the capability of the physical (PHY) layer. In this mode, the ARLC detection mechanism 130 monitors the capability of the downlink (DL) PHY layer and the uplink (UL) PHY layer. In at least some embodiments, capability refers to the expected throughput of the UE device 102 based on radio resources allocated by the cellular network 100 and the current block error rate (BLER). When either the DL or UL capability for voice traffic is below a threshold value, the ARLC detection mechanism 130 generates an RLD indication to inform one or more other components of the UE device 102 of the detected adverse radio link condition. Stated differently, the ARLC detection mechanism 130, in this example, detects an adverse radio link condition based on the monitored parameter of the capability. In at least some embodiments, the likely cause of the RLD, such as low DL or UL capability, is also sent to the other component(s) of the UE device 102.

An additional mode includes a fourth ARLC detection mode 208 in which the ARLC detection mechanism 130 monitors for transmission (Tx) power deficit at the UE device 102. A Tx power deficit occurs when the actual Tx power does not equal the target Tx power and is typically caused by the capping of the maximum transmission power level (MTPL) or an internal error. As a result, the actual applied Tx power is lower than the MTPL. Tx power deficit affects UL packet transmission when the Tx deficit is large and persistent (for example, throughput at one or more of the layers can be reduced). When many voice packets are lost, an active voice call is likely to drop or at least experience poor audio quality. When path loss is significant, targeted Tx power becomes high, which potentially increases the Tx deficit. As such, when the ARLC detection mechanism 130 detects a Tx deficit above a threshold, the ARLC detection mechanism 130 generates an RLD indication to inform one or more other components of the UE device 102 of the detected adverse radio link condition. Stated differently, the ARLC detection mechanism 130, in this example detects an adverse radio link condition based on the monitored parameter of the transmission power deficit. In at least some embodiments, the likely cause of the RLD, such as a Tx power deficit, is also sent to the other component(s) of the UE device 102. In this mode, the ARLC detection mechanism 130, in at least some embodiments, also monitors the protocol data unit (PDU) flow at the dedicated voice radio bearer to more accurately estimate the impact of the Tx power deficit on voice traffic.

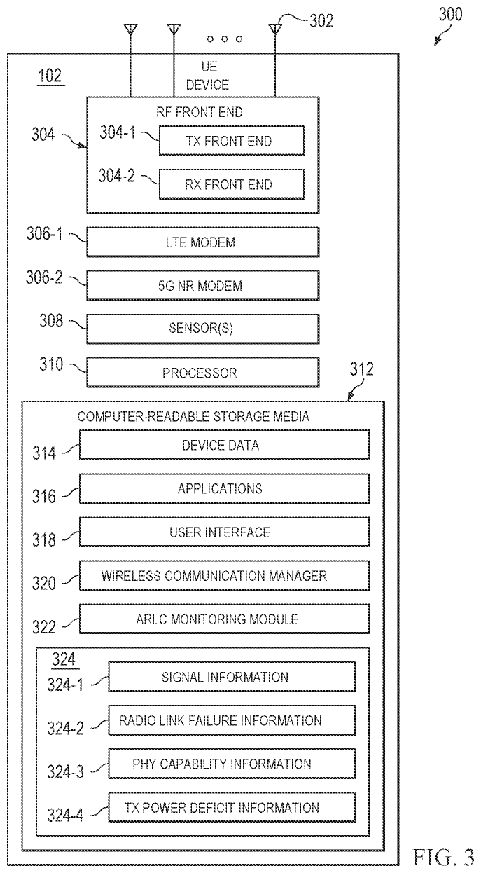

FIG. 3 illustrates an example device diagram 300 of a UE device 102. In at least some embodiments, the device diagram 300 describes a UE device that implements various aspects of detecting adverse radio link conditions for voice calls in or near real-time. The UE device 102 may include additional functions and interfaces that are omitted from FIG. 3 for the sake of clarity. The UE device 102, in at least some embodiments, includes antennas 302, a radio frequency (RF) front end 304, and one or more RF transceivers 306 (e.g., a 3GPP 4G LTE transceiver 306-1 and a 5G NR transceiver 306-2) for communicating with one or more base stations 104 in a RAN 110, such as a 5G RAN, an E-UTRAN, a combination thereof, and so on. The RF front end 304, in at least some embodiments, includes a transmitting (Tx) front end 304-1 and a receiving (Rx) front end 304-2. The Tx front end 304-1 includes components such as one or more power amplifiers (PA), drivers, mixers, filters, and so on. The Rx front end 304-2 includes components such as low-noise amplifiers (LNAs), mixers, filters, and so on. The RF front end 304, in at least some embodiments, couples or connects the one or more transceivers 306, such as the LTE transceiver 306-1 and the 5G NR transceiver 306-2, to the antennas 302 to facilitate various types of wireless communication.

In at least some embodiments, the antennas 302 of the UE device 102 include an array of multiple antennas configured similar to or different from each other. The antennas 302 and the RF front end 304, in at least some embodiments, are tuned to or are tunable to one or more frequency bands, such as those defined by the 3GPP LTE, 3GPP 5G NR, IEEE wireless local area network (WLAN), IEEE wireless metropolitan area network (WMAN), or other communication standards. In at least some embodiments, the antennas 302, the RF front end 304, the LTE transceiver 306-1, and the 5G NR transceiver 306-2 are configured to support beamforming (e.g., analog, digital, or hybrid) or in-phase and quadrature (I/Q) operations (e.g., I/Q modulation or demodulation operations) for the transmission and reception of communications with one or more base stations 104. By way of example, the antennas 302 and the RF front end 304 operate in sub-gigahertz bands, sub-6 GHz bands, above 6 GHz bands, or a combination of these bands defined by the 3GPP LTE, 3GPP 5G NR, or other communication standards.

In at least some embodiments, the antennas 302 include one or more receiving antennas positioned in a one-dimensional shape (e.g., a line) or a two-dimensional shape (e.g., a triangle, a rectangle, or an L-shape) for implementations that include three or more receiving antenna elements. While the one-dimensional shape enables the measurement of one angular dimension (e.g., an azimuth or an elevation), the two-dimensional shape enables two angular dimensions to be measured (e.g., both azimuth and elevation). Using at least a portion of the antennas 302, the UE device 102 can form beams that are steered or un-steered, wide or narrow, or shaped (e.g., as a hemisphere, cube, fan, cone, or cylinder). The one or more transmitting antennas may have an un-steered omnidirectional radiation pattern or may produce a wide steerable beam. Either of these techniques enables the UE device 102 to transmit a radio signal to illuminate a large volume of space. In some embodiments, the receiving antennas generate thousands of narrow steered beams (e.g., 2000 beams, 4000 beams, or 6000 beams) with digital beamforming to achieve desired levels of angular accuracy and angular resolution.

The UE device 102, in at least some embodiments, includes one or more sensors 308 implemented to detect various properties such as one or more of temperature, supplied power, power usage, battery state, or the like. Examples of sensors include a thermal sensor, a battery sensor, a power usage sensor, and so on.

The UE device 102 also includes at least one processor 310. The processor 310, in at least some embodiments, is a single-core processor or a multiple-core processor composed of a variety of materials, such as silicon, polysilicon, high-K dielectric, copper, and so on. In at least some embodiments, the processor 310 is implemented at least partially in hardware including, for example, components of an integrated circuit or a system-on-a-chip (SoC), a digital-signal-processor (DSP), an application-specific integrated circuit (ASIC), a field-programmable gate array (FPGA), a complex programmable logic device (CPLD), other implementations in silicon or other hardware, or a combination thereof.

Examples of the processor(s) 310 include a communication processor, an application processor, microprocessors, DSPs, controllers, and so on. A communication processor, in at least some embodiments, is implemented as a modem baseband processor, software-defined radio module, configurable modem (e.g., multi-mode, multi-band modem), wireless data interface, wireless modem, or so on. In at least some embodiments, a communication processor supports one or more of data access, messaging, or data-based services of a wireless network, as well as various audio-based communication (e.g., voice calls). An application processor, in at least some embodiments, provides computing resources to applications executing on the UE device 102. For example, an application provides a self-contained operating environment that delivers system capabilities (e.g., graphics processing, memory management, and multimedia processing) to support applications executing on the UE device 102.

The UE device 102 further includes a non-transitory computer-readable storage media 312 (CRM 312). The computer-readable storage media described herein excludes propagating signals. The CRM 312, in at least some embodiments, includes any suitable memory or storage device such as random-access memory (RAM), static RAM (SRAM), dynamic RAM (DRAM), non-volatile RAM (NVRAM), read-only memory (ROM), or Flash memory useable to store device data 314 of the UE device 102. In at least some embodiments, the device data 314 includes user data, multimedia data, beamforming codebooks, applications 316, a user interface(s) 318, an operating system of the UE device 102, and so on, which are executable by the processor(s) 310 to enable user-plane communication, control-plane signaling, and user interaction with the UE device 102. The user interface 318, in at least one embodiment, is configured to receive inputs from a user of the UE device 102, such as to receive input from a user that defines and or facilitates one or more aspects of adverse radio link condition detection. In at least some embodiments, the user interface 318 includes a graphical user interface (GUI) that receives the input information via a touch input. In other instances, the user interface 318 includes an intelligent assistant that receives the input information via an audible input or speech. Alternatively, or additionally, the operating system of the UE device 102 is maintained as firmware or an application on the CRM 312 and executed by the processor(s) 310.

The CRM 312, in at least some embodiments, also includes either or both of a communication manager 320 and an ARLC monitoring module 322. Alternatively, or additionally, either or both of the communication manager 320 and the ARLC monitoring module 322, in at least some embodiments, are implemented in whole or part as hardware logic or circuitry integrated with or separate from other components of the UE device 102. In at least some embodiments, the communication manager 320 configures the RF front end 304, the LTE transceiver (modem) 306-1, the 5G NR transceiver (modem) 306-2, or a combination thereof, to perform one or more wireless communication operations.

The ARLC monitoring module 322, in at least some embodiments, implements the ARLC detection mechanism(s) 130 for detecting adverse radio link conditions and radio link failures in or near real-time. For example, the ARLC monitoring module 322 is configured to perform one or more of low signal-based ARLC detection 202, RLF-based ARLC detection 204, PHY layer capability-based ARLC detection 206, and transmission power deficit-based ARLC detection 208. As described in greater detail below, the ARLC monitoring module 322, in at least some embodiments, performs ARLC monitoring by collecting information across various network protocol stack layers within one or more processors 310 of the UE device 102, the information representative of factors or parameters associated with maintaining a voice call connection with acceptable quality. By analyzing the key factors across network protocol stack layers, the configured UE component detects radio link issues in real-time or near real-time with improved accuracy over conventional radio link failure mechanisms. Upon detecting a radio link failure (or potential failure), the configured UE component notifies another UE component, such as an application processor, so that appropriate actions can be taken to mitigate operational and user experience issues caused by the radio link failure or impending failure.

In at least some embodiments, the CRM 312 further includes ARLC monitoring information 324 used by the ARLC monitoring module 322 to perform voice call ARLC monitoring operations. The ARLC monitoring information 324, in at least some embodiments, includes signal information 324-1, RLF information 324-2, PHY layer capability information 324-3, transmission power deficit information 324-4, and so on. The signal information 324-1, in at least some embodiments, includes information such as signal-related characteristics/parameters (e.g., RSRP, RSRQ, CINR, SINR, and so on) signal strength measurements, signal strength thresholds, and so on. The RLF information 324-2 information, in at least some embodiments, includes information such as out-of-synch indications (e.g., an N310 indication), timer (e.g., a T310 timer) information, in-sync indications (e.g., an N311 indication), RLD indications, radio resource control (RRC) connection re-establishment indications, RLC retransmission indications, and so on. The PHY layer capability information 324-3, in at least some embodiments, includes information such as uplink capability information and downlink capability information. Downlink PHY layer capability information includes, for example, downlink bandwidth requirements, current throughput at RLC layer of a dedicated voice radio bearer, PHY capability low indications, RLD indications, and so on. Uplink PHY layer capability information includes, for example, RLC PDUs on the dedicated bearer for ongoing voice traffic, currently achieved uplink PHY layer capability, PHY capability low indications, RLD indications, and so on. The transmission power deficit information 324-4, in at least some embodiments, includes information such as number of instances when the transmission power deficit is larger than a deficit margin, ratio of high deficit instances, ratio thresholds, throughput of voice packets of PLC PDU, throughput of generated voice traffic, RLD indications, and so on.

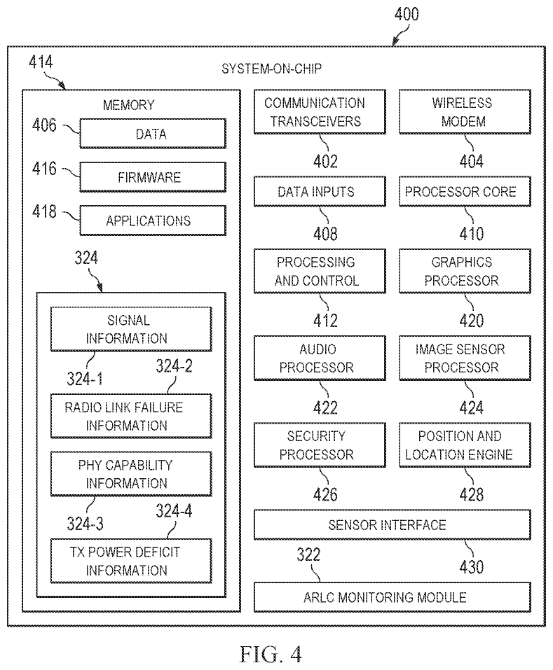

FIG. 4 illustrates an example system-on-chip (SoC) 400 that, in at least some embodiments, implements various aspects of the ARLC monitoring techniques described herein. The SoC 400 may include additional functions and interfaces that are omitted from FIG. 4 for the sake of clarity. In at least some embodiments, the SoC 400 is embodied as or within any type of UE device 102 or another device/system to implement ARLC monitoring for active voice calls. Although described with reference to chip-based packaging, the components shown in FIG. 4 may also be embodied as other systems or component configurations, such as, and without limitation, a field-programmable gate array (FPGA), an application-specific integrated circuit (ASIC), an application-specific standard product (ASSP), a digital signal processor (DSP), complex programmable logic devices (CPLD), system-in-package (SiP), package-on-package (POP), processing and communication chipset, communication co-processor, sensor co-processor, and so on.

In the example shown in FIG. 4, the SoC 400 includes communication transceivers 402 and a wireless modem 404 that enable wired or wireless communication of data 406 (e.g., received data, data that is being received, data scheduled for broadcast, packetized, and so on). In at least some embodiments, the wireless modem 404 is a multi-mode multi-band modem or baseband processor configurable to communicate in accordance with various communication protocols, in different frequency bands, or a combination thereof. In addition, the wireless modem 404, in at least some embodiments, includes a transceiver interface (not shown) for communicating encoded or modulated signals with transceiver circuitry.

In at least some embodiments, the data 406 or other system content includes configuration settings of the SoC 400 or various components, media content stored by the system, and or information associated with a system user. Media content stored on the SoC 400 includes any type of audio, video, and or image data. The SoC 400 also includes one or more data inputs 408 via which any type of data, media content, and or inputs can be received, such as user input, user-selectable inputs (explicit or implicit), or any other type of audio, video, and or image data received from a content source and or a data source. Alternatively, or additionally, the data inputs 408 include various data interfaces, which are implementable as any one or more of a serial and or parallel interface, a wireless interface, a network interface, or as any other type of communication interface enabling communication with other devices or systems.

The SoC 400 includes one or more processor cores 410 that process various computer-executable instructions to control the operation of the SoC 400 and to enable techniques for voice call ARLC monitoring. Alternatively, or additionally, the SoC 400 is implemented with any one or combination of hardware, firmware, or fixed logic circuitry that is implemented in connection with processing and control circuits 412. Although not shown, the SoC 400 includes one or more of a bus, interconnect, crossbar, or fabric that couples the various components within the SoC 400.

The SoC 400 also includes a memory 414 (e.g., computer-readable media), such as one or more memory circuits that enable persistent and or non-transitory data storage and thus do not include transitory signals or carrier waves. Examples of the memory 414 include RAM, SRAM, DRAM, NV-RAM, ROM, EPROM, or Flash memory. The memory 414 provides data storage for the system data 406, firmware 16, applications 418, and any other type of information and or data related to operational aspects of the SoC 400. For example, the firmware 416, in at least some embodiments, is maintained as processor-executable instructions of an operating system (e.g., real-time OS) within the memory 414 and executed on one or more of the processor cores 410.

The applications 418, in at least some embodiments, include a system manager, such as any form of a control application, software application, signal-processing and control module, code that is native to a particular system, an abstraction module, gesture module, or the like. In at least some embodiments, the memory 414 also stores one or more of system components, utilities, or information for implementing aspects of the voice call ARLC monitoring techniques described herein, such as signal information 324-1, RLF information 324-2, PHY layer capability information 324-3, transmission power deficit information 324-4, and so on.

In at least some embodiments, the SoC 400 includes the ARLC monitoring module 322. The ARLC monitoring module 322, in at least some embodiments, is implemented, in whole or in part, through hardware or firmware or at least partially in the memory 414. The SoC 400, in at least some embodiments, also includes additional processors or co-processors to enable other functionalities, such as a graphics processor 420, an audio processor 422, and an image sensor processor 424. The graphics processor 420, in at least some embodiments, renders graphical content associated with a user interface, operating system, or applications of the SoC 400. In some instances, the audio processor 422 encodes or decodes audio data and signals, such as audio signals and information associated with voice calls or encoded audio data for playback. The image sensor processor 424, in at least some embodiments, is coupled to an image sensor and provides image data processing, video capture, and other visual media conditioning and processing functions.

The SoC 400, in at least some embodiments, also includes a security processor 426 to support various security, encryption, and cryptographic operations, such as to provide secure communication protocols and encrypted data storage. Although not shown, the security processor 426 includes, in at least some embodiments, one or more cryptographic engines, cipher libraries, hashing modules, or random number generators to support encryption and cryptographic processing of information or communications of the SoC 400. Alternatively, or additionally, the SoC 400 includes a position and location engine 428 and a sensor interface 430. Generally, the position and location engine 428 provides positioning or location data by processing signals of a global navigation satellite system (GNSS) and or other motion or inertia sensor data (e.g., dead-reckoning navigation). The sensor interface 430 enables the SoC 400 to receive data from various sensors, such as capacitance and motion sensors.

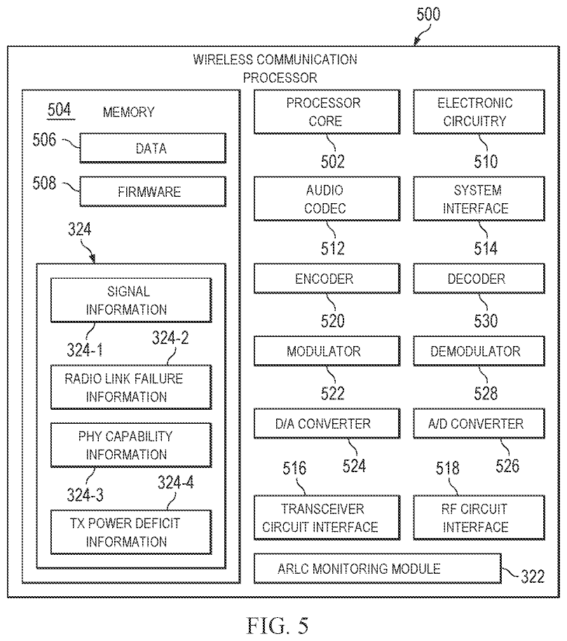

FIG. 5 illustrates an example configuration of a wireless communication processor (CP) 500 that, in at least some embodiments, implements various aspects of the ARLC monitoring techniques described herein. The SoC 400 may include additional functions and interfaces that are omitted from FIG. 5 for the sake of clarity. Although referred to generally as a communication processor, the communication processor 500, in at least some embodiments, is implemented as a modem baseband processor, software-defined radio module, configurable modem (e.g., multi-mode, multi-band modem), wireless data interface, or wireless modem, such as the RF transceiver 306 of the UE device 102 or the wireless modem 404 of the SoC 400. In at least some embodiments, the communication processor 500 is implemented in a device or system, such as the UE device 102, to support data access, messaging, or data-based services of a wireless network, as well as various audio-based communication (e.g., voice calls).

In this example, the communication processor 500 includes at least one processor core 502 and a memory 504. The processor core 502, in at least some embodiments, is configured as any suitable type of processor core, microcontroller, digital signal processor core, or the like. The memory 504 is implemented as hardware-based memory that enables persistent storage and excludes propagating signals. In at least some embodiments, the memory 504 includes any suitable type of memory device or circuit, such as RAM, DRAM, SRAM, non-volatile memory, flash memory, or the like. Generally, the memory stores data 506 of the communication processor 500, the firmware 508, and other applications. The processor core 502, in at least some embodiments, executes processor-executable instructions of the firmware 508 or applications to implement functions of the communication processor 500, such as signal processing and data encoding operations. The memory 504, in at least some embodiments, also stores one or more of system components, utilities, or information for implementing aspects of the voice call ARLC monitoring techniques described herein. For example, the memory 504 includes signal information 324-1, RLF information 324-2, PHY layer capability information 324-3, transmission power deficit information 324-4, and so on.

In at least some embodiments, the communication processor 500 includes the ARLC monitoring module 322. The ARLC monitoring module 322, in at least some embodiments, is implemented, in whole or in part, through hardware or firmware or at least partially in the memory 504. The communication processor 500, in at least some embodiments, also includes electronic circuitry 510 for managing or coordinating operations of various components and an audio codec 512 for processing audio signals and data. In at least some embodiments, the electronic circuitry 510 includes hardware, fixed logic circuitry, or physical interconnects (e.g., traces or connectors) implemented in connection with processing and control circuits of the communication processor 500 and various components. The audio codec 512, in at least some embodiments, includes a combination of logic, circuitry, or firmware (e.g., algorithms) to support encoding and or decoding of audio information and audio signals, such as analog signals and digital data associated with voice or sound functions of the communication processor 500.

A system interface 514 of the communication processor 500 enables communication with a host system or application processor. For example, the communication processor 500 provides or exposes data access functionalities to the system or application processor through the system interface 514. In this example, the communication processor 500 also includes a transceiver circuit interface 516 and an RF circuit interface 518 through which the communication processor 500 manages or controls respective functionalities of a transceiver circuit or RF front end to implement various communication protocols and techniques. In various aspects, the communication processor 500 includes digital signal processing or signal processing blocks for encoding and modulating data for transmission or demodulating and decoding received data.

In at least some embodiments, the communication processor 500 includes an encoder 520, modulator 522, and digital-to-analog converter 524 (D/A converter 524) for encoding, modulating, and converting data sent to the transceiver circuit interface 516. The communication processor 500 also includes an analog-to-digital converter 526 (A/D converter 526), demodulator 528, and decoder 530 for converting, demodulating, and decoding data received from the transceiver circuit interface 516. In at least some embodiments, these signal processing blocks and components are implemented as respective transmit and receive chains of the communication processor 500, configurable for different radio access technologies or frequency bands.

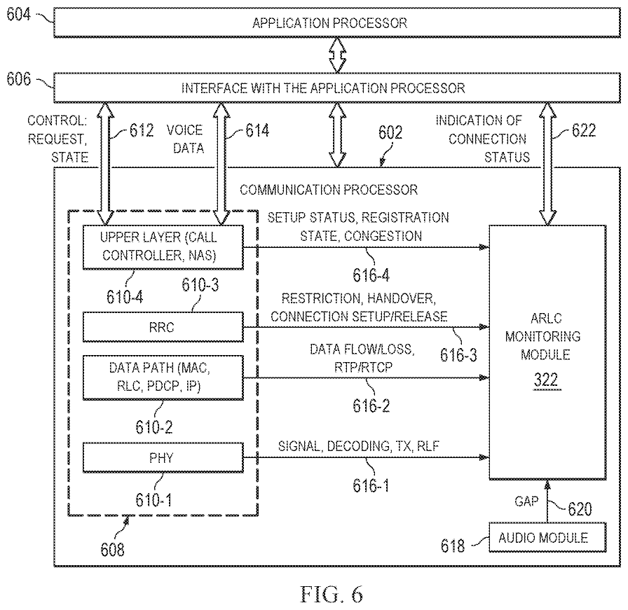

FIG. 6 illustrates a functional block diagram of a communication processor 602 implementing the ARLC monitoring module 322. In at least some embodiments, the communication processor 602 of FIG. 6 is embodied as the communication processor 500 described above with respect to FIG. 5. In the example illustrated in FIG. 6, the communication processor 602 is communicatively coupled to one or more other components 604 of the UE device 102, such as an application processor. In at least some embodiments, the communication processor 602 is coupled to the UE component 604 via one or more interfaces 606, such as one or more messaging channels, for transmitting information to and receiving information from the UE component 604.

In at least some embodiments, the communication processor 602 implements a network protocol stack 608 (communication stack 608) through which the UE device 102 communicates with entities of the mobile cellular network 100. For example, the UE device 102 utilizes the communication stack 608 to communicate with entities such as cells or core networks of the mobile cellular network 100. Although not shown, the communication stack 608 includes a user plane and a control plane, each comprised of one or more of the layers 610 (shown as layers 610-1 to 610-4). Upper layers of the user plane and the control plane share common lower layers in the communication stack 608. It should be understood that the terms “upper layer” and “lower layer” are relative to one another, with each layer in the communication stack 608 being an “upper layer” to a layer lower (a “lower layer”) in the communication stack 608. The UE device 102 implements each layer within the communication processor 602 as an entity for communication with another device using respective protocols defined for the layer. For example, the UE device 102 uses an RRC entity to communicate to a peer RRC entity in a base station 104 using an appropriate RRC protocol or RRC connection.

The shared lower layers include a physical (PHY) layer 610-1 and one or more layers illustrated as data path layers 610-2. Examples of data path layers 610-2 that are shared lower layers include a media access control (MAC) layer, a radio link control (RLC) layer, and a packet data convergence protocol (PDCP) layer. Generally, the PHY layer 610-1 provides hardware specifications for devices that communicate with each other, and the MAC layer specifies how data is transferred between devices. The RLC layer provides, for example, data transfer services to higher layers in the communication stack 608. For example, the RLC layer transfers upper layer protocol data units (PDU), provides error correction, and so on. The PDCP layer provides, for example, data transfer services of user plane data and control plane data.

Above the PDCP layer, the communication stack 608 splits into the user plane and the control plane. Layers of the user plane include, for example, an internet protocol (IP) layer, a transport layer (not shown), and an application layer (not shown). The user plane, in at least some embodiments, also includes a service data adaptation protocol (SDAP) layer for quality of service (QOS) flow implementation and management in 5G NR networks. Generally, the IP layer (shown in FIG. 6 as one of the data path layers 610-2) specifies how the data from the application layer is transferred to a destination node. The transport layer verifies that data packets intended to be transferred to the destination node reached the destination node, using either transmission control protocol (TCP) or user datagram protocol (UDP) for data transfers by the application layer. In at least some embodiments, the user plane also includes a data services layer (not shown) that provides data transport services to transport application data, such as IP packets including web-browsing content, video content, image content, audio content, social media content, and so on.

The control plane of the communication stack 608 includes an RRC layer 610-3 and one or more upper layers 610-4, such as an application layer/controller and a non-access stratum (NAS) layer. The RRC layer establishes and releases radio connections and radio bearers, broadcasts system information, or performs power control. The NAS layer supports mobility management and packet data bearer contexts between the UE device 102 and entities or functions in the core network 112. In the example of FIG. 6, one or more of Upper layers 610-4 receive call-related information/requests 612 from the UE component 604 via the AP interface 606. For example, the UE component 604 provides a call request to the upper layer(s) 610-4 along with related call state information, such as network coverage information (e.g., LTE, 5G, etc.), IP multimedia subsystem (IMS) registration status, and so on. In some instances, the UE component 604 provides voice data 614 to one or more of the Upper layers 610-4 via the AP interface 606. In embodiments where the UE device 102 implements the communication processor 602, each layer in both the user plane and the control plane of the communication stack 608 interacts with a corresponding peer layer or entity in a cell, a core network entity or function, and or a remote service, to support user applications and control operation of the UE device 102 in the RAN 110.

In at least some embodiments, the communication processor 602 includes the ARLC monitoring module 322. As described above, the ARLC monitoring module 322 implements the ARLC detection mechanism(s) 130 for detecting adverse radio link conditions and radio link failures in or near real-time. The ARLC monitoring module 322, in at least some embodiments, integrates with the communication stack 608 to access various stack information/parameters 616 (shown as 616-1 to 616-4) from one or more layers 610 of the communication stack 608. For example, the ARLC monitoring module 322 accesses PHY layer information 616-1, such as signal information (e.g., signal strength quality), decoding information, transmission power information, radio link failure information, and so on. In another example, the ARLC monitoring module 322 accesses data path layer information 616-2, such as data flow/loss information (e.g., data lost due to decoding error, poor signal, etc.), real-time transport protocol (RTP) information, RTP control protocol (RTCP) information, and so on. In yet another example, the ARLC monitoring module 322 accesses RRC layer information 616-3, such as network restriction information (e.g., a period of time service for a group of devices is blocked or not available), handover information, connection setup/release information, and so on. In a further example, the ARLC monitoring module 322 accesses upper layer information 616-4, such as setup status information (e.g., dial, ringing, pickup/connected, etc.), registration state information (e.g., a service of the device is restricted), and congestion information.

In at least some embodiments, the ARLC monitoring module 322 is also coupled to an audio processing module 618 of the communication processor 602 for accessing audio gap information 620. Audio gaps typically occur during handover procedures due to the UE device 102 disconnecting from one cell and connecting to a different cell. The ARLC monitoring module 322 interacts with the audio processing module 618 to determine when audio gaps occur, their duration, and so on. As described in greater detail below, the ARLC monitoring module 322 monitors and processes the stack information 616, audio gap information 620, or a combination thereof to detect or predict adverse radio link conditions that likely caused or will potentially cause RLD (e.g., a voice call radio link failure or poor audio conditions). The ARLC monitoring module 322 generates an output 622 (RLD indication 622) based on processing the stack information 616, the audio gap information 620, or a combination thereof. In at least some embodiments, the output 622 of the ARLC monitoring module 322 is a connection status indicator for an active voice call that indicates when a radio link failure has occurred or is likely to occur, the likely causes of the radio link failure or potential failure, and so on. In at least some embodiments, the output 622 also indicates the likely causes of poor audio quality that has occurred or may potentially occur during the active voice call. The output 622, in at least some embodiments, indicates the cause of the RLD using a mechanism, such as a flag, bit, bitmask, array, and so on. The ARLC monitoring module 322, in at least some embodiments, transmits the output 622 to the UE component 604 via the AP interface 606. The UE component 604, in at least some embodiments, utilizes the output 622 received from the ARLC monitoring module 322 to take one or more actions, such as switching an active call to another mode (e.g., VoWiFi) to save the call, notifying the user that the call is likely to drop or its quality is likely to degrade, notifying the user of the reasons the call dropped, and so on.

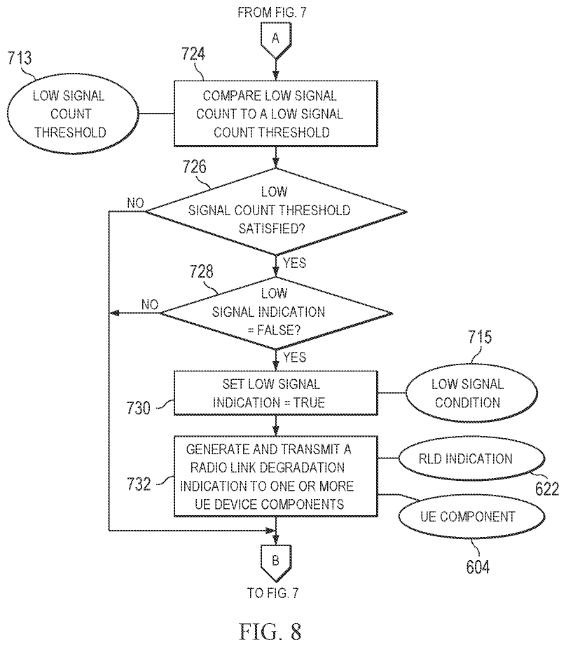

FIG. 7 and FIG. 8 together illustrate, in flow chart form, one example method 700 of a communication processor 500 (or another component) of UE device 102 performing a first mode of ARLC monitoring based on low signal strength. In this example method 700, the ARLC monitoring module 322 monitors signal strength updates performed by the UE device 102 to detect low signal strength occurrences. When low signal strength has been detected a threshold number of times, the ARLC monitoring module 322 notifies another component of the UE device 102, such as the UE component 604, of an RLD condition and the likely cause of the RLD condition, such as low signal strength.

Referring to block 702 of FIG. 7, the ARLC monitoring module 322 detects an active voice call 701 at the UE device 102. For example, a user of the UE device 102 places an outgoing voice call or accepts an incoming voice call using one or more applications executing on the UE device 102. In at least some embodiments, the ARLC monitoring module 322 determines that the voice call 701 has been initiated based on monitoring the communication stack 608. The ARLC monitoring module 322, at block 704, initially sets a low signal indication 703 to FALSE (or equivalent) in response to the voice call being initiated. The low signal indication 703, in at least some embodiments, is a mechanism, such as a flag, bit, bitmask, array, and so on, implemented by the ARLC monitoring module 322 to track when low signal strength has been detected for the current voice call 701.

The ARLC monitoring module 322 monitors one or more layers 610 of the communication stack 608 during the active voice call 701. At least one parameter associated with maintenance of the active voice call can be monitored across the one or more layers 610. The ARLC monitoring module 322, at block 706, determines that the UE device 102 has performed a signal strength update 705. For example, the ARLC monitoring module 322 monitors the communication stack 608 for information or messages that indicate a signal strength update 705 has been performed. In another example, one or more components of the UE device 102 notifies the ARLC monitoring module 322 that a signal strength update 705 has been performed. In at least some embodiments, the UE device 102 performs a signal strength update 705 by calculating signal strength for one or more signals of the serving cell and or a target cell(s) in response to one or more trigger events. For example, the UE device 102 typically measures signal strength for handover events when the UE device 102 is in a connected mode (e.g., when a voice call is active). In another example, the UE device 102 measures signal strength periodically or in response to other trigger events. The UE device 102 determines the measurement criteria for signal strength based on specific RRC messages received from the base station 104.

In at least some embodiments, one or more components of the UE device 102, such as the communication processor 500, determines the signal strength of a cell based on signal (strength)-related characteristics 707. For LTE-based signals, the UE device 102 determines signal-related characteristics associated with a cell-specific reference signal (CRS). For 5G NR-based signals, the UE device 102 determines signal-related characteristics associated with a synchronization signal (SS) and channel state information (CSI) instead of CRS. Examples of signal-related characteristics 707 include measurements such as RSRP, RSRQ, CINR/SINR, and so on. An RSRP measurement is defined as the average power (in Watts) of the resource elements (REs) that carry cell-specific reference signals (RSs) within the considered bandwidth. Stated differently, an RSRP measurement is a power measurement for a signal subcarrier. An RSRQ measurement is defined as the ratio of the reference signal power over the total and indicates the quality of the received signal. A CINR/SINR measurement is defined as the signal strength of a certain signal of interest divided by the sum of the signal strength of co-channel interfering signals and the thermal noise generated by the receiver electronics. In at least some embodiments, the ARLC monitoring module 322 obtains at least one of the signal-related characteristics 707 from one or more layers 610 of the communication stack 608, a component(s) of the UE device 102, memory/storage (e.g., CRM 312) of the UE device 102, or the like. In one example, the ARLC monitoring module 322 receives signal-related characteristics 707 as part of the PHY layer information 616-1 and stores this information 616-1 as signal information 324-1.

Upon determining that a signal strength update 705 has occurred, the ARLC monitoring module 322 compares one or more of the signal-related characteristics 707 to a corresponding low signal threshold 709. However, in at least some embodiments, the ARLC monitoring module 322, at block 708, first determines if transmission time interval (TTI) bundling is enabled based on information obtained from, for example, the PHY layer 610-1. TTI bundling is typically enabled to optimize the uplink coverage at the cell edge for services such as voice over LTE (VOLTE). When TTI bundling is enabled, the UE device 102 sends the same packet in a given number of consecutive TTIs to increase the robustness of the radio link. If TTI bundling is enabled, the ARLC monitoring module 322, at block 710, selects a first set of low signal thresholds 709-1 for the signal-related characteristics 707. If TTI bundling is disabled, the ARLC monitoring module 322, at block 712, selects a second set of low signal thresholds 709-2 for the signal-related characteristics 707. In at least some embodiments, a low signal threshold 709 is a value or range of values that a corresponding signal-related characteristic is compared to for determining if an instance of low signal strength has occurred. The second set of low signal thresholds 709-2, in at least some embodiments, are set lower than the first set of low signal thresholds 709-1 because the UE device 102 is at the cell edge and robustness of the radio link is increased when TTI is enabled. In at least some embodiments, the first set of low signal thresholds 709-1 and the second set of low signal thresholds 709-2 each include an RSRP threshold, an RSRQ threshold, and a CINR/SINR threshold. In at least some embodiments, TTI bundling is not considered, and the method flows directly from block 706 to block 710.

The ARLC monitoring module 322, at block 714, compares one or more of the signal-related characteristics 707 to its corresponding low signal threshold(s) either in the first set of low signal thresholds 709-1 or the second set low signal thresholds 709-2 depending on whether TTI bundling is enabled and considered. For example, the ARLC monitoring module 322 compares an RSRP measurement to an RSRQ threshold, an RSRQ measurement to an RSRQ threshold, a CINR/SINR measurement to a CINR/SINR threshold, or a combination thereof. In one example, if TTI is not enabled, the ARLC monitoring module 322 determines if one or more of an RSRP measurement is less than-125 decibel-milliwatts (dBm), an RSRQ measurement is less than-20 decibels (dB), a CINR/SINR measurement is less than −3 dB, or a combination thereof. In an example where TTI is enabled, the ARLC monitoring module 322 determines if one or more of an RSRP measurement is less than-120 dBm, an RSRQ measurement is less than-15 dB, a CINR/SINR measurement is less than 0 dB, or a combination thereof. It should be understood that these threshold values are only for illustration purposes and other threshold values (or range of values) are also applicable.

The ARLC monitoring module 322, at block 716, determines if each of the one or more signal-related characteristics 707 satisfies or fails to satisfy a corresponding low signal threshold 709. It should be understood that throughout this description, satisfying or failing to satisfy a threshold refers to a corresponding value being one of less than, greater than, or equal to the threshold depending on how the threshold and comparison process are configured. In one example, failing to satisfy a low signal threshold 709 indicates that the signal-related characteristic 707 has a value that is greater than or equal to the low signal threshold 709. However, the low signal thresholds 709 are configurable such that, in other examples, satisfying a low signal threshold 709 indicates that an instance of low signal has not occurred.

In the current example, if each of the one or more signal-related characteristics 707 fails to satisfy a corresponding low signal threshold 709, the ARLC monitoring module 322 determines that an instance of low signal has not occurred and sets a low signal count 711 to 0, at block 718. The ARLC monitoring module 322, at block 720, determines if the low signal indication 703 is set to FALSE (or an equivalent). If the low signal indication 703 is not set to FALSE, the flow returns to block 704, where the ARLC monitoring module 322 sets the low signal indication 703 to FALSE. However, if the ARLC monitoring module 322 determines that the low signal indication 703 is set to FALSE, the flow returns to block 706, where the ARLC monitoring module 322 monitors for a signal strength update 705.

If any of the one or more signal-related characteristics 707 satisfy their corresponding low signal threshold 709, the ARLC monitoring module 322, at block 722, increments the low signal count 711. The ARLC monitoring module 322, at block 724 (FIG. 8), compares the low signal count 711 to a low signal count threshold 713. The ARLC monitoring module 322, at block 726, determines if the low signal count 711 satisfies the low signal count threshold 713. If the low signal count 711 fails to satisfy the low signal count threshold 713, the flow returns to block 706, where the ARLC monitoring module 322 monitors for a signal strength update 705. However, if the low signal count 711 satisfies the low signal count threshold 713, the ARLC monitoring module 322, at block 728, determines if the low signal indication 703 is currently set to FALSE. If the signal indication 703 is currently set to FALSE, the ARLC monitoring module 322, at block 730, sets the low signal indication 703 to TRUE (or an equivalent). Otherwise, the flow returns to block 706, where the ARLC monitoring module 322 monitors for a signal strength update 705. When the low signal indication 703 is set to TRUE, the ARLC monitoring module 322 has detected a low signal condition 715 (or a potential low signal condition) for the radio link associated with the active voice call. For example, responsive to monitoring one or more of the layers 610, at least one adverse radio link condition associated with the active voice call is detected. The detection, in at least some embodiments, is based on the monitored parameter(s), which can satisfy a low signal condition or criteria.

Upon setting the low signal indication 703 to FALSE, the ARLC monitoring module 322, at block 732, generates an RLD indication 622 and transmits the RLD indication 622 to one or more UE components 604, such as an application processor. For example, a radio link degradation (RLD) indication 622 is provided to component(s) 604 of the UE device 102 in response to detecting the at least one adverse radio link condition. In at least some embodiments, the RLD indication 622 includes information indicating that radio link degradation has occurred or will likely occur for the active voice call and also includes a likely cause of the RLD, such as the detected low signal condition 715. The RLD indication 622, in at least some embodiments, also includes one or more of the RSRP, RSRQ, CINR/SINR measurements used to determine that the low signal condition 715 has occurred. In at least some embodiments, the UE component 604 utilizes the RLD indication 622 to take one or more actions, such as switching an active call to another mode (e.g., VoWiFi) to save the call, notifying the user that the call is likely to drop or its quality is likely to degrade, notifying the user of the reasons the call dropped, and so on. The flow returns to block 706, where the ARLC monitoring module 322 monitors for a signal strength update 705. The above-described processes are repeated until the voice call 701 terminates or is dropped.

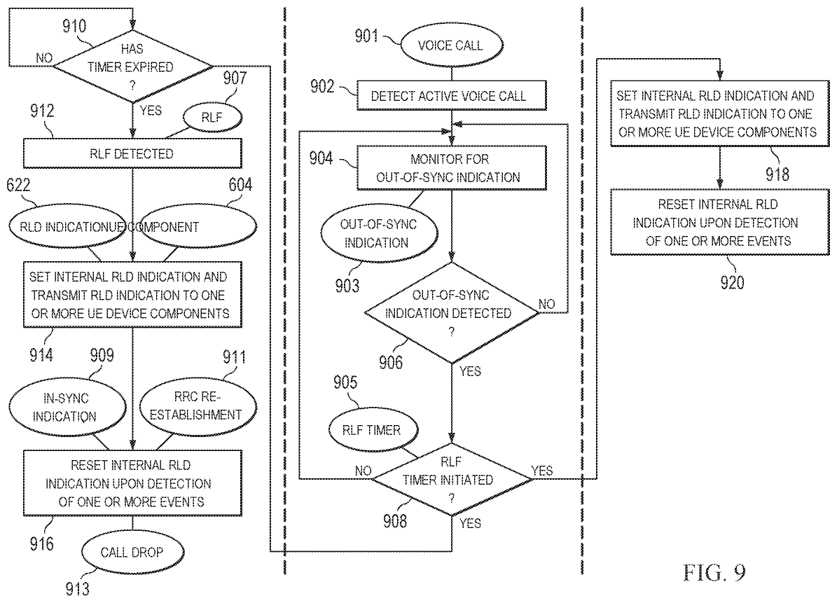

FIG. 9 illustrates, in flow chart form, one example method 900 of a communication processor 500 (or another component) of UE device 102 performing a second mode of ARLC monitoring based on RLFs. In this example method 900, the ARLC monitoring module 322 monitors for RLFs due to out-of-sync conditions. Referring to block 902 of FIG. 9, the ARLC monitoring module 322 detects an active voice call 901 at the UE device 102. For example, a user of the UE device 102 places an outgoing voice call or accepts an incoming voice call using one or more applications executing on the UE device 102. In at least some embodiments, the ARLC monitoring module 322 determines that the voice call 901 has been initiated based on monitoring the communication stack 608.

The ARLC monitoring module 322 monitors one or more layers 610 of the communication stack 608 during the active voice call 701. At least one parameter associated with maintenance of the active voice call can be monitored across the one or more layers 610. The ARLC monitoring module 322, at block 904, monitors for an out-of-sync indication 903 (e.g., an N310 indication) associated with the active voice call. In one example, an out-of-sync condition occurs when the UE device 102 is unable to successfully decode a PDCCH. In at least some embodiments, the UE device 102 monitors one or more layer 610 of the communication stack 608 to detect when an out-of-sync indication 903 is generated. The ARLC monitoring module 322, at block 906, determines if an out-of-sync indication 903 has been detected. If an out-of-sync indication 903 has not been detected, the ARLC monitoring module 322 continues to monitor for out-of-sync indications 903 at block 904. However, if an out-of-sync indication 903 has been detected, the ARLC monitoring module 322, at block 908, determines if an RLF timer 905 (e.g., a T310 timer) has been initiated. In at least some embodiments, the RLF timer 905 is initiated by one or more network protocol stack layers 610 after a threshold number of consecutive out-of-sync indications 903 has been received/detected. The ARLC monitoring module 322, in at least some embodiments, monitors the network protocol stack layers 610 to detect when an RLF timer 905 has been initiated. If an RLF timer 905 has not been initiated, the flow returns to block 904, where the ARLC monitoring module 322 continues to monitor for out-of-synch conditions. However, if an RLF timer 905 has been initiated, the ARLC monitoring module 322 performs one of a plurality of options.

In a first option, the ARLC monitoring module 322, at block 910, determines if the RLF timer 905 has expired. If the RLF timer 905 has not expired, the ARLC monitoring module 322 continues monitoring for the expiry of the RLF timer 905. If the RLF timer 905 has expired, the ARLC monitoring module 322, at block 912, determines that an RLF 907 has occurred. For example, responsive to monitoring one or more of the layers 610, at least one adverse radio link condition associated with the active voice call is detected. The detection, in one example, is based on the monitored parameter(s), which can satisfy an RLF condition or criteria.

The ARLC monitoring module 322, at block 914, sets an internal RLD indication 622 and transmits the RLD indication 622 to one or more components 604 of the UE device 102, such as an application processor. For example, a radio link degradation (RLD) indication 622 is provided to component(s) 604 of the UE device 102 in response to detecting the at least one adverse radio link condition. In at least some embodiments, the RLD indication 907 includes information indicating that a radio link failure has occurred or will likely occur for the active voice call and also includes a likely cause of the RLD, such as an out-of-sync condition. The UE component 604, in at least some embodiments, utilizes the RLD indication 622 to take one or more actions, such as switching an active call to another mode (e.g., VoWiFi) to save the call, notifying the user that the call is likely to drop or its quality is likely to degrade, notifying the user of the reasons the call dropped, and so on. The ARLC monitoring module 322, at block 916, monitors one or more of the network protocol stack layers 610 and resets the internal RLD indication 622 upon detecting one or more events, such as an in-sync condition/indication 909, successful RRC re-establishment 911, call drop 913, and so on. One example of an in-sync indication is defined in the 3GPP standards for 4G LTE and 5G NR. An N311 indication identifies the number of intervals during which the UE device 102 was able to successfully decode a PDCCH while the RLF timer 905 was running. The UE device 102, in at least some embodiments, performs an RRC re-establishment procedure upon expiry of the RLF timer 905. If the RRC re-establishment process is unsuccessful, the call is dropped. In at least some embodiments, if the UE component 604 handles RLD indications on a per-call basis, the UE component 604 clears the RLD indication 907 received from the ARLC monitoring module 322.

In a second option, the ARLC monitoring module 322, at block 918, sets the internal RLD indication 907 and transmits the RLD indication 907 to the UE component 604 upon initiation of the RLF timer 905. For example, a radio link degradation (RLD) indication 622 is provided to component(s) 604 of the UE device 102 in response to detecting the at least one adverse radio link condition. The ARLC monitoring module 322, at block 920, monitors one or more of the network protocol stack layers 610 and resets the internal RLD indication 622 upon detecting one or more events, such as an in-sync indication 909, successful RRC re-establishment 911, call drop 913, and so on. In at least some embodiments, if the UE component 604 handles RLD indications on a per-call basis, the UE component 604 clears the RLD indication 907 received from the ARLC monitoring module 322.

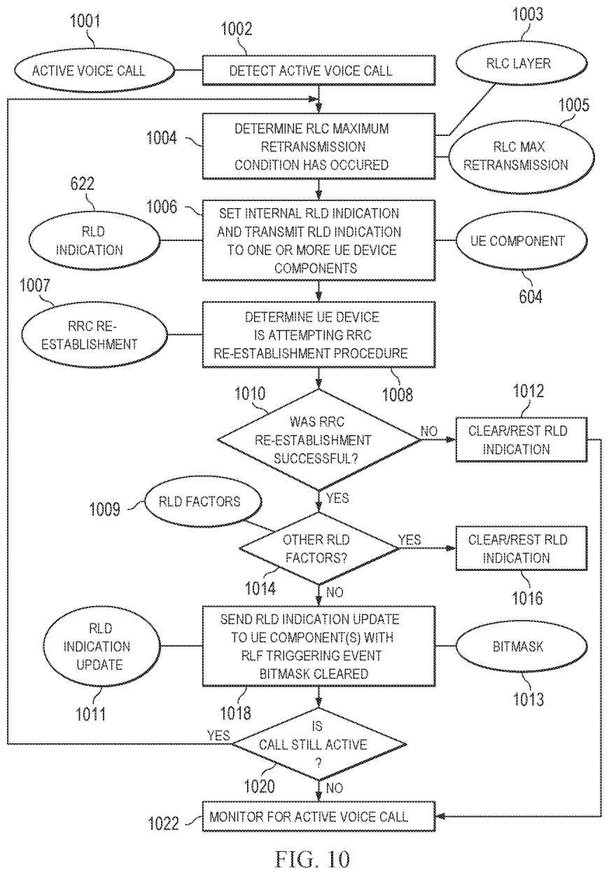

FIG. 10 illustrates, in flow chart form, another example method 1000 of a communication processor 500 (or another component) of UE device 102 performing a second mode of ARLC monitoring based on radio link failures (RLF). In the example method 1000, the ARLC monitoring module 322 monitors for RLFs due to an RLC maximum retransmission condition occurring during data traffic transmission when the UE device 102 is in RLC acknowledged mode (AM). For example, voice traffic is typically transmitted using RLC unacknowledged (UM) mode and is not retransmitted. However, data traffic is usually transmitted using RLC AM. In RLC AM mode, an RLF is triggered if the maximum retransmission threshold is reached. An RLF for data traffic indicates that radio conditions are problematic for both data and voice traffic, and their data radio bearers (DRBs) should be similarly impacted. Also, if an RRC connection re-establishment is not successful for data traffic, the DRBs for both voice traffic and data traffic are dropped, resulting in a dropped voice call. As such, in the example method 1000 shown in FIG. 10, the ARLC monitoring module 322 monitors RLC retransmission even though the retransmission is not for voice traffic.

Referring to block 1002 of FIG. 10, the ARLC monitoring module 322, at block 1002, detects an active voice call 1001 at the UE device 102. For example, a user of the UE device 102 places an outgoing voice call or accepts an incoming voice call using one or more applications executing on the UE device 102. In at least some embodiments, the ARLC monitoring module 322 determines that the voice call 1001 has been initiated based on monitoring the communication stack 608. The ARLC monitoring module 322, at block 1004, monitors one or more of the network protocol stack layers 610 (e.g., RLC layer 1003) and determines that an RLC maximum retransmission condition 1005 has occurred. For example, the ARLC monitoring module 322 monitors one or more layers 610 of the communication stack 608 during the active voice call 701. At least one parameter associated with maintenance of the active voice call can be monitored across the one or more layers 610. An RLC maximum retransmission condition 1005 occurs, for example, when the UE device 102 receives a STATUS PDU that includes negative acknowledgment (NACK) information indicating some PDUs were not received in the previous transmission. In response, the UE device 102 attempts to retransmit the missing PDUs. Retransmission occurs until either all PDUs are received by the receiving entity or a maximum retransmission threshold is reached for the PDUs associated with the NACK. If the maximum retransmission threshold has been reached, an RLC maximum retransmission condition 1005 occurs and is detected by one or more of the network protocol stack layers 610. For example, responsive to monitoring the plurality of layers 610, at least one adverse radio link condition associated with the active voice call is detected. The detection, in at least some embodiments, is based on the monitored parameter(s), which can satisfy an RLC maximum retransmission condition or criteria.

The ARLC monitoring module 322, at block 1006, sets an internal RLD indication 622 and transmits the RLD indication 622 to one or more UE components 604, such as an application processor. For example, a radio link degradation (RLD) indication 622 is provided to component(s) 604 of the UE device 102 in response to detecting the at least one adverse radio link condition. In at least some embodiments, the RLD indication 622 includes information indicating that a radio link failure has occurred or will likely occur for the active voice call and also includes a likely cause of the RLD, such as RLC maximum retransmission. The UE component 604, in at least some embodiments, utilizes the RLD indication 622 to take one or more actions, such as switching an active call to another mode (e.g., VoWiFi) to save the call, notifying the user that the call is likely to drop or its quality is likely to degrade, notifying the user of the reasons the call dropped, and so on.

The ARLC monitoring module 322, at block 1008, monitors one or more of the network protocol stack layers 610 and determines that the UE device 102 is attempting an RRC re-establishment operation 1007. The ARLC monitoring module 322, at block 1010, determines if the RRC re-establishment operation 1007 was successful. If the RRC re-establishment operation 1007 was unsuccessful, the ARLC monitoring module 322, at block 1012, clears/rests its RLD indication 622 (e.g., status=FALSE). The ARLC monitoring module 322 then monitors for a new active voice call at block 1022. If the RRC re-establishment operation 1007 was successful, the ARLC monitoring module 322, at block 1014, determines if any other ARLCs (RLD factors or parameters) 1009 are causing or may potentially cause radio link degradation. Examples of these other monitored parameters or factors 1009 include the low signal condition, the out-of-sync condition, the PHY low capability condition, and the Tx power deficit condition described herein. If at least one factor 1009 is causing or may potentially cause RLD, the ARLC monitoring module 322, at block 1016, sends an RLD indication update 1011 to the UE component 604 with the RLF triggering event bitmask 1013 cleared. In at least one embodiment, the RLF triggering event bitmask 1013 is a bitmask sent as part of the RLD indication 622 that indicates an RLF has occurred. The RLF triggering event bitmask 1013, in at least some embodiments, also identifies the cause(s) of the RLF. If there are no factors 1009 causing or may potentially cause RLD, the ARLC monitoring module 322, at block 1018, clears/rests its RLD indication 622 (e.g., status=FALSE). The ARLC monitoring module 322, at block 1020, determines if the voice call 1001 is still active. If so, the flow returns to block 1004. If the voice call 901 is no longer active, the ARLC monitoring module 322, at block 1022, monitors for a new active voice call.

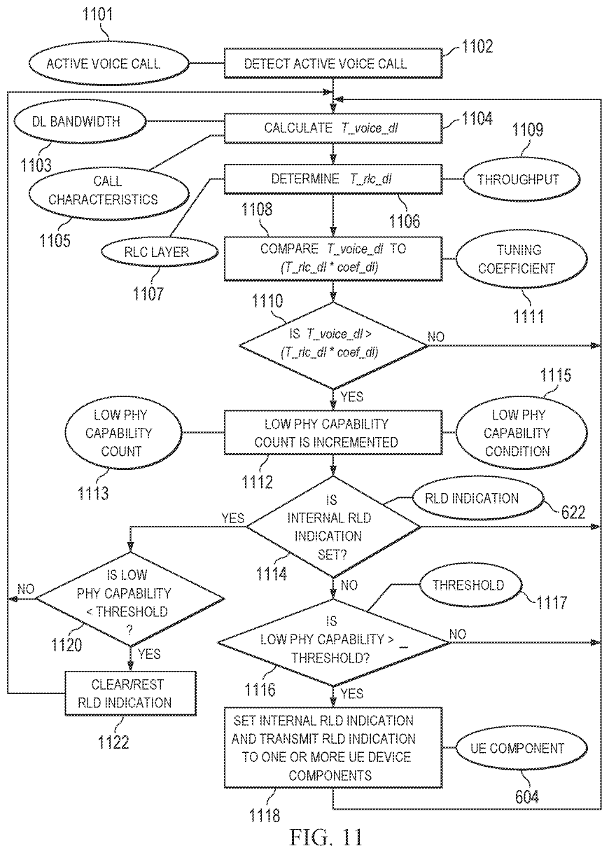

FIG. 11 illustrates, in flow chart form, an example method 1100 of a communication processor 500 (or another component) of UE device 102 performing a third mode of ARLC monitoring based on the capability of the PHY layer 610-1 on the downlink. Typically, voice traffic has priority over data traffic. However, a voice call is likely to drop when the entire PHY capability (throughput) is lower than the required bandwidth to carry ongoing voice traffic. Examples of factors that limit PHY capability include high BLER, limited resource block (RB) allocation from the network, and so on. As such, in the example method 1100 of FIG. 11, the ARLC monitoring module 322 monitors for low PHY capability 1115 as an adverse radio link condition.

Referring to block 1102 of FIG. 11, the ARLC monitoring module 322 detects an active voice call 1101 at the UE device 102. For example, a user of the UE device 102 places an outgoing voice call or accepts an incoming voice call using one or more applications executing on the UE device 102. In at least some embodiments, the ARLC monitoring module 322 determines that the voice call 1101 has been initiated based on monitoring the communication stack 608. The ARLC monitoring module 322, at block 1104, monitors one or more of the network protocol stack layers 610 (e.g., PHY layer 610-1) to calculate the required downlink bandwidth (T_voice_dl) 1103 for the current voice traffic based on, for example, call characteristics 1105, such as the type of codec being used for the voice call 1101 and the voice pattern (e.g., active or silent). The ARLC monitoring module 322, at block 1106, also monitors one or more other network protocol stack layers 610 (e.g., RLC layer 1107) to determine the current throughput (T_rlc_dl) 1109 of the dedicated voice radio bearer, which is limited by the PHY capability at this network protocol stack layer 610. For example, the ARLC monitoring module 322 monitors one or more of layers 610 of the communication stack 608 during the active voice call 701. At least one parameter associated with maintenance of the active voice call can be monitored across the one or more layers 610.

The ARLC monitoring module 322, at block 1108, compares the required downlink bandwidth (T_voice_dl) 1103 to the current throughput (T_rlc_dl) 1109 of the dedicated voice radio bearer multiplied by a tuning coefficient (coef_dl) 1111, which is based on a ratio between required voice bandwidth and actual available bandwidth. The ARLC monitoring module 322, at block 1110, determines if the required downlink bandwidth 1103 is greater than the tuned current throughput 1109 of the dedicated voice radio bearer (i.e., is T_voice_dl> (T_rlc_dl*coef_dl)). If the required downlink bandwidth 1103 is not greater than the tuned current throughput 1109 of the dedicated voice radio bearer, the control flow returns to block 1104, and the operations at blocks 1104 to 1112 are repeated until the voice call 1101 is terminated or dropped. If the required downlink bandwidth 1103 is greater than the tuned current throughput 1109 of the dedicated voice radio bearer, the ARLC monitoring module 322, at block 1112, increments the low PHY capability count 1113.

The ARLC monitoring module 322, at block 1114, determines if an internal RLD indication 622 is set (e.g., status=TRUE). If the internal RLD indication 622 is not set, the ARLC monitoring module 322, at block 1116, determines if the low PHY capability count 1113 is greater than (or equal to) a low PHY capability count threshold 1117 (N_th 1117). If so, the ARLC monitoring module 322, at block 1118, determines that a low PHY capability condition (1115) has been detected and sets the internal RLD indication 622 (e.g., status=TRUE). For example, responsive to monitoring the plurality of layers 610, at least one adverse radio link condition associated with the active voice call is detected. The detection, in at least some embodiments, is based on the monitored parameter(s), which can satisfy a low PHY capability condition or criteria.

The ARLC monitoring module 322 also transmits the RLD indication 622 to one or more UE components 604, such as an application processor. For example, radio link degradation (RLD) indication 622 is provided to component(s) 604 of the UE device 102 in response to detecting the at least one adverse radio link condition. In at least some embodiments, the RLD indication 622 includes information indicating that radio link degradation has occurred or will likely occur for the active voice call and also includes a likely cause of the RLD, such as low PHY capability on the downlink. The UE component 604, in at least some embodiments, utilizes the RLD indication 622 to take one or more actions, such as switching an active call to another mode (e.g., VoWiFi) to save the call, notifying the user that the call is likely to drop or its quality is likely to degrade, notifying the user of the reasons the call dropped, and so on. The control flow returns to block 1104, and the operations at blocks 1104 to 1118 are repeated until the voice call 1101 is terminated or dropped. If the low PHY capability count 1113 does not satisfy (e.g., is less than) the low PHY capability count threshold 1117, the control flow returns to block 1104, and the operations at blocks 1104 to 1116 are repeated until the voice call 1101 is terminated or dropped.

Referring back to block 1114, If the internal RLD indication 622 is set, the ARLC monitoring module 322, at block 1120, determines if the low PHY capability count 1113 is less than the low PHY capability count threshold 1117. If the low PHY capability count 1113 is not less than the low PHY capability count threshold 1117, the control flow returns to block 1104, and the operations at blocks 1104 to 1120 are repeated until the voice call 1101 is terminated or dropped. If the low PHY capability count 1113 is less than the low PHY capability count threshold 1117, the ARLC monitoring module 322, at block 1122, clears/resets its internal RLD indication 1117 (e.g., status=FALSE). The control flow returns to block 1104, and the operations at blocks 1104 to 1122 are repeated until the voice call 1101 is terminated or dropped. Also, if at any point the ARLC monitoring module 322 determines that the voice call has been dropped, the ARLC monitoring module 322 clears/resets its internal RLD indication 622 and monitors for an active voice call.

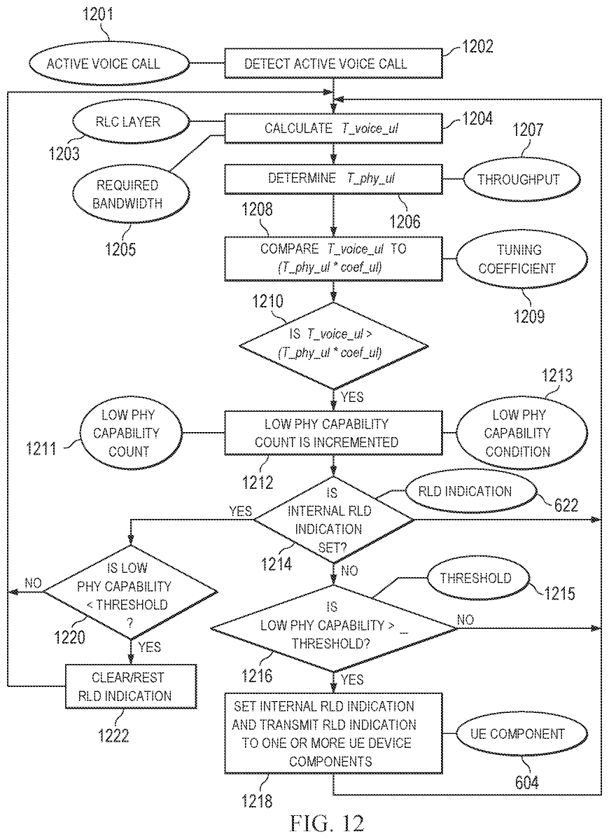

FIG. 12 illustrates, in flow chart form, another example method 1200 of a communication processor 500 (or another component) of UE device 102 performing the third mode of ARLC monitoring based on the capability of the PHY layer 610-1 on the uplink. Similar to the downlink example described above, voice traffic has higher priority over data traffic. However, when the PHY capability is not able to support the voice traffic generated at the UE device 102, a voice call is likely to drop, or at least audio quality suffers. Different from traffic on the downlink, the amount of desired uplink voice traffic is generated locally by the UE device 102 (RTP packets→RLC PDU). Therefore, there is no need to estimate voice traffic as done in the downlink example.

Referring to block 1202 of FIG. 12, the ARLC monitoring module 322 detects an active voice call 1201 at the UE device 102. For example, a user of the UE device 102 places an outgoing voice call or accepts an incoming voice call using one or more applications executing on the UE device 102. In at least some embodiments, the ARLC monitoring module 322 determines that the voice call 1201 has been initiated based on monitoring the communication stack 608. The ARLC monitoring module 322, at block 1204, monitors one or more of the network protocol stack layers 610 (e.g., RLC layer 1203) to determine a required bandwidth (T_voice_ul) 205 for outgoing voice traffic on the dedicated bearer based on RLC PDUs. The ARLC monitoring module 322, at block 1206, monitors the PHY layer 610-1 to obtain the current achieved uplink PHY capability/throughput 1207 (T_phy_ul 1207). Various factors affect the uplink PHY capability/throughput 1207. Examples of these factors include uplink allocation, Tx power, retransmission due to NACK (BLER), and so on. As such, in at least some embodiments, the ARLC monitoring module 322 monitors one or more parameters associated with maintenance of the active voice call across at least one layer of the communication stack 608.

The ARLC monitoring module 322, at block 1208, compares the required bandwidth (T_voice_ul) to the uplink PHY capability 1207 (T_phy_ul) multiplied by a tuning coefficient 1209 (coef_ul). The ARLC monitoring module 322, at block 1210, determines if the required bandwidth 1205 is greater than the tuned uplink PHY capability 1207 (i.e., is T_voice_ul> (T_phy_ul*coef_ul)). If the required bandwidth 1205 is not greater than the tuned uplink PHY capability 1207, the control flow returns to block 1204, and the operations at blocks 1204 to 1210 are repeated until the voice call 1201 is terminated or dropped. However, if the required bandwidth 1205 is greater than the tuned uplink PHY capability 1207, the ARLC monitoring module 322, at block 1212, determines that low PHY capability condition 1213 exists and increments a low PHY capability count (N_low_ul) 1211. For example, at least one adverse radio link condition associated with the active voice call is detected based on the monitored parameter(s), which can satisfy a low PHY capability condition or criteria.

The ARLC monitoring module 322, at block 1214, determines if an internal RLD indication 622 is set (e.g., status=TRUE). If the internal RLD indication 622 is not set, the ARLC monitoring module 322, at block 1216, determines if the low PHY capability count 1211 is greater than (or equal to) a low PHY capability count threshold 1215 (N_th) 1215. If so, the ARLC monitoring module 322, at block 1218, sets the internal RLD indication 622 (e.g., status=TRUE) and transmits the RLD indication 622 to one or more UE components, such as an application processor. For example, a radio link degradation (RLD) indication 622 is provided to component(s) 604 of the UE device 102 in response to detecting the at least one adverse radio link condition. In at least some embodiments, the RLD indication 622 includes information indicating that radio link degradation has occurred or will likely occur for the active voice call and includes a likely cause of the RLD, such as low PHY capability 1213 on the uplink. The UE component 604, in at least some embodiments, utilizes the RLD indication 622 to take one or more actions, such as switching an active call to another mode (e.g., VoWiFi) to save the call, notifying the user that the call is likely to drop or its quality is likely to degrade, notifying the user of the reasons the call dropped, and so on. The control flow returns to block 1204, and the operations at blocks 1204 to 1218 are repeated until the voice call 1201 is terminated or dropped. If the low PHY capability count 1211 does not satisfy (e.g., is less than) the low PHY capability count threshold 1215, the control flow returns to block 1204, and the operations at blocks 1204 to 1218 are repeated until the voice call 1201 is terminated or dropped.

Referring back to block 1214, if the internal RLD indication 622 is set, the ARLC monitoring module 322, at block 1220, determines if the low PHY capability count 1211 is less than the low PHY capability count threshold 1215. If the low PHY capability count 1211 is not less than the low PHY capability count threshold 1215, the control flow returns to block 1204, and the operations at blocks 1204 to 1220 are repeated until the voice call 1101 is terminated or dropped. If the low PHY capability count 1211 is less than the low PHY capability count threshold 1215, the ARLC monitoring module 322, at block 1222, clears/resets (e.g., status=FALSE) the internal RLD indication 622. The control flow returns to block 1204, and the operations at blocks 1204 to 1222 are repeated until the voice call 1201 is terminated or dropped. Also, if at any point the ARLC monitoring module 322 determines that the voice call has been dropped, the ARLC monitoring module 322 clears/resets its internal RLD indication 622 and monitors for an active voice call.

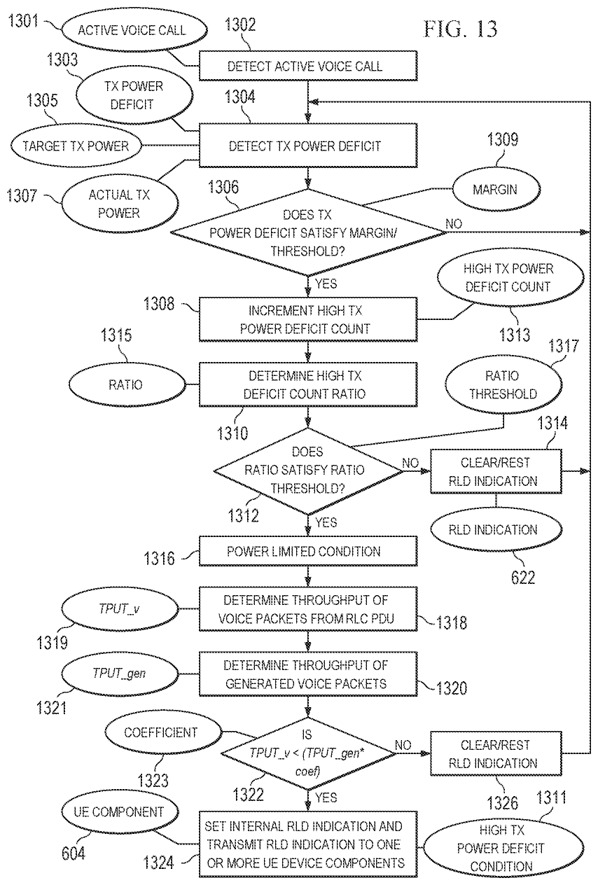

FIG. 13 illustrates, in flow chart form, an example method 1300 of a communication processor 500 (or another component) of UE device 102 performing a fourth mode of ARLC monitoring based on transmission power deficit. In at least some embodiments, a Tx power deficit is equal to a target Tx power minus the actual Tx power. A Tx power deficit is typically caused by the capping of MTPL or by internal error. A Tx power deficit usually results in the actual applied Tx power being lower than MTPL and can cause an active voice call to drop or experience poor audio quality. As such, in the example method 1300 of FIG. 13, the ARLC monitoring module 322 monitors for a Tx power deficit. Also, in at least some embodiments, the ARLC monitoring module 322 also monitors RLC PDU flow at the dedicated voice radio bearer to more accurately estimate the impact of a Tx power on voice traffic.

Referring to block 1302 of FIG. 13, the ARLC monitoring module 322 detects an active voice call 1301 at the UE device 102. For example, a user of the UE device 102 places an outgoing voice call or accepts an incoming voice call using one or more applications executing on the UE device 102. In at least some embodiments, the ARLC monitoring module 322 determines that the voice call 1301 has been initiated based on monitoring the communication stack 608. The ARLC monitoring module 322, at block 1304, monitors one or more of the network protocol stack layers 610 (e.g., PHY layer 610-1) detects a Tx power deficit (P_d) 1303 during the active voice call 1301. For example, the ARLC monitoring module 322 monitors one or more layers 610 of a plurality of layers of the communication stack 608 during the active voice call 701. At least one parameter associated with maintenance of the active voice call can be monitored across the one or more layers 610. In at least some embodiments, the ARLC monitoring module 322 determines that a Tx power deficit 1303 exists by obtaining target Tx power information 1305 and actual Tx power information 1307 from the PHY layer 610-1. If the actual Tx power is less than the target Tx power, a Tx power deficit exists. The ARLC monitoring module 322, at block 1306, compares the Tx power deficit 1303 to a Tx power deficit margin/threshold (Th) 1309. If the Tx power deficit 1303 fails to satisfy (e.g., is less than) the Tx power deficit margin 1309, the control flow returns to block 1304. However, if the Tx power deficit 1303 satisfies (e.g., is greater than) the Tx power deficit margin 1309, the ARLC monitoring module 322, at block 1308, considers this Tx power deficit instance as a “high” Tx power deficit condition 1311 and increments a high Tx power deficit count 1313.

The ARLC monitoring module 322, at block 1310, determines a high Tx power deficit count ratio 1315 for one or more monitoring windows of N Tx instances. For example, if N=10 and the Tx power deficit count for these 10 Tx instances is 7, the ratio of high Tx power deficit counts is calculated as 7/10=70%. The ARLC monitoring module 322, at block 1312, compares the ratio 1315 to a ratio threshold 1317. If the ratio 1315 fails to satisfy (e.g., is less than) the ratio threshold 1317, the ARLC monitoring module 322, at block 1314, determines that the UE device 102 is not in a power-limited condition and clears/resets any RLD indication 622. The control flows to block 1304, and the operations at blocks 1304 to 1314 are repeated until the voice call 1301 is terminated or dropped. If the ratio 1315 satisfies (e.g., is greater than) the ratio threshold 1317, the ARLC monitoring module 322, at block 1316, determines that the UE device 102 is in a power-limited condition.

The ARLC monitoring module 322, at block 1318, monitors one or more of the network protocol stack layers 610 to determine the throughput (TPUT_v) 1319 of voice packets from RLC PUD. The ARLC monitoring module 322, at block 1320, also monitors one or more of the network protocol stack layers 610 to determine the throughput (TPUT_gen) 1321 of generated voice packets, which is codec dependent. The ARLC monitoring module 322, at block 1322, determines if TPUT_v 1319 is less than TPUT_gen 1321 multiplied by a coefficient (coef) 1323. For example, responsive to monitoring the plurality of layers 610, at least one adverse radio link condition associated with the active voice call is detected. The detection, in at least some embodiments, is based on the monitored parameter(s), which can satisfy condition or criteria of TPUT_v 1319 being less than TPUT_gen 1321 multiplied by a coefficient (coef) 1323.

If TPUT_v 1319 is less than TPUT_gen 1321 multiplied by a coefficient (coef) 1323, the ARLC monitoring module 322, at block 1324, sets the internal RLD indication 622 (e.g., status=TRUE) and transmits the RLD indication 622 to one or more UE components, such as an application processor. For example, radio link degradation (RLD) indication 622 is provided to component(s) 604 of the UE device 102 in response to detecting the at least one adverse radio link condition. In at least some embodiments, the RLD indication 622 includes information indicating that radio link degradation has occurred or will likely occur for the active voice call and also includes a likely cause of the RLD, such as a high Tx power deficit. The UE component 604, in at least some embodiments, utilizes the RLD indication 622 to take one or more actions, such as switching an active call to another mode (e.g., VoWiFi) to save the call, notifying the user that the call is likely to drop or its quality is likely to degrade, notifying the user of the reasons the call dropped, and so on. If TPUT_v 1319 is greater than (or equal to) TPUT_gen 1321 multiplied by the coefficient 1323, the ARLC monitoring module 322, at block 1326, clears/resets any RLD indication 622. If the voice call 1301 is still active, the control flows to block 1304, and the operations at blocks 1304 to 1326 are repeated until the voice call 1301 is terminated or dropped. Also, if at any point the ARLC monitoring module 322 determines that the voice call has been dropped, the ARLC monitoring module 322 clears/resets its internal RLD indication 622 and monitors for an active voice call.

In some embodiments, certain aspects of the techniques described above may be implemented by one or more processors of a processing system executing software. The software comprises one or more sets of executable instructions stored or otherwise tangibly embodied on a non-transitory computer-readable storage medium. The software can include the instructions and certain data that, when executed by the one or more processors, manipulate the one or more processors to perform one or more aspects of the techniques described above. The non-transitory computer-readable storage medium can include, for example, a magnetic or optical disk storage device, solid-state storage devices such as Flash memory, a cache, random access memory (RAM), or other non-volatile memory device or devices, and the like. The executable instructions stored on the non-transitory computer-readable storage medium may be in source code, assembly language code, object code, or other instruction format that is interpreted or otherwise executable by one or more processors.

A computer-readable storage medium may include any storage medium or combination of storage media accessible by a computer system during use to provide instructions and or data to the computer system. Such storage media can include, but is not limited to, optical media (e.g., compact disc (CD), digital versatile disc (DVD), Blu-ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer-readable storage medium may be embedded in the computing system (e.g., system RAM or ROM), fixedly attached to the computing system (e.g., a magnetic hard drive), removably attached to the computing system (e.g., an optical disc or universal serial bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed is not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified, and all such variations are considered within the scope of the disclosed subject matter. Accordingly, the protection sought herein is as set forth in the claims below.

1. A method at a first component of a cellular user equipment (UE) device for detecting adverse radio link conditions, the method comprising:
monitoring a plurality of layers of a communication stack of the UE device during an active voice call;
responsive to monitoring the plurality of layers, detecting at least one adverse radio link condition associated with the active voice call; and
providing a radio link degradation (RLD) indication to a second component of the UE device in response to detecting the at least one adverse radio link condition.

2. The method of claim 1, wherein the RLD indication notifies the second component that the at least one adverse radio link condition exists and identifies a cause of the at least one adverse radio link condition.

3. The method of claim 1, wherein providing the RLD indication comprises providing the RLD indication to the second component during the active voice call.

4. The method of claim 1, wherein detecting the at least one adverse radio link condition comprises:
responsive to monitoring the plurality of layers, detecting a signal strength update;
responsive to detecting the signal strength update, accessing one or more signal-related characteristics associated with the signal strength update;
determining if a value associated with any of the one or more signal-related characteristics satisfies a corresponding threshold; and
responsive to the value associated with any of the one or more signal-related characteristics satisfying the corresponding threshold, determining that the at least one adverse radio link condition exists.

5. The method of claim 4, comprising:
determining if transmission time interval bundling is enabled at the UE device;
responsive to TTI bundling being enabled, selecting the corresponding threshold from a first set of thresholds; and
responsive to TTI bundling being disabled, selecting the corresponding threshold from a second set of thresholds, wherein the second set of thresholds are set lower than the first set of thresholds.

6. The method of claim 1, wherein the detected at least one adverse radio link condition is an out-of-sync condition, and wherein providing the RLD indication comprises:
determining that a radio link failure (RLF) timer has been initiated in response to the out-of-sync condition occurring; and
providing the RLD indication to the second component upon initiation of the RLF timer and prior to the RLF timer expiring.

7. The method of claim 6, comprising:
responsive to detecting one of the following:
an in-sync condition occurring while the RLF timer is active,
the RLF timer having expired, or
the RLF timer having expired and the UE device successfully performing a radio resource control (RRC) connection re-establishment procedure,
resetting an RLD indication internally maintained by the first component.

8. The method of claim 1, wherein the detected at least one adverse radio link condition is an out-of-sync condition, and wherein the method comprises:
determining that a radio link failure (RLF) timer has expired, the RLF timer having been initiated in response to the out-of-sync condition (903) occurring;
responsive to the RLF timer having expired, determining that the UE device (102) has successfully performed a radio resource control (RRC) connection re-establishment procedure; and
responsive to the successful RRC connection re-establishment procedure (911), resetting an RLD indication internally maintained by the first component.

9. The method of claim 1, wherein the detected at least one adverse radio link condition is a radio link control (RLC) maximum retransmission condition associated with data traffic, and wherein providing the RLD indication comprises:
determining that the RLC maximum retransmission condition resulted in a radio link failure (RLF); and
responsive to the RLF, providing the RLD indication to the second component.

10. The method of claim 9, comprising:
determining that the UE device has successfully completed a radio resource control (RRC) connection re-establishment procedure in response to the RLF;
responsive to the successful completion of the RRC connection re-establishment procedure, determining if any other adverse radio link conditions exist;
responsive to at least one other adverse radio link condition existing, providing an updated RLD indication to the second component indicating that the least one other adverse radio link condition exists and that the RLC maximum retransmission condition no longer exists; and
responsive to no other adverse radio link conditions existing, resetting an RLD indication internally maintained by the first component.

11. The method of claim 1, wherein detecting the at least one adverse radio link condition comprises:
determining a required bandwidth at a first layer of the plurality of layers for current voice traffic on a downlink channel associated with the active voice call;
determining a current throughput at a second layer of the plurality of layers on a dedicated voice radio bearer associated with the active voice call; and
responsive to the required bandwidth being greater than the current throughput, determining that a low capability condition exists at the first layer.

12. The method of claim 11, wherein detecting the at least one adverse radio link condition comprises:
responsive to determining that a low capability condition exists, incrementing a low capability count; and
comparing the low capability count to a low capability count threshold,
wherein the RLD indication is provided to the second component (604) responsive to the low capability count satisfying the low capability count threshold.

13. The method of claim 12, wherein responsive to the low capability count failing to satisfy the low capability count threshold, resetting an RLD indication internally maintained by the first component indicating the at least one adverse radio link condition exists.

14. The method of claim 1, wherein detecting the at least one adverse radio link condition comprises:
determining a required bandwidth for outgoing voice traffic associated with the active voice call at a first layer of the plurality of layers;
determining a currently achieved throughput at a second layer of the plurality of layers on an uplink channel associated with the active voice call; and
responsive to the required bandwidth being greater than the currently achieved throughput, determining that a low capability condition exists at the second layer.

15. The method of claim 14, wherein detecting the at least one adverse radio link condition comprises:
responsive to determining that a low capability condition exists, incrementing a low capability count; and
comparing the low capability count to a low capability count threshold,
wherein the RLD indication is provided to the second component responsive to the low capability count satisfying the low capability count threshold.

16. The method of claim 15, wherein responsive to the low capability count failing to satisfy the low capability count threshold, resetting an RLD indication internally maintained by the first component indicating the at least one adverse radio link condition exists.

17. The method of claim 1, wherein detecting the at least one adverse radio link condition comprises:
determining that a high transmission power deficit condition exists; and
determining that a throughput of outgoing voice packets at a first layer of the plurality of layers is less than a throughput of voice traffic generated at a second layer of the plurality of layers.

18. The method of claim 17, wherein determining that a high transmission power deficit condition exists comprises:
detecting a transmission power deficit;
comparing the transmission power deficit to a transmission power deficit threshold;
responsive to the transmission power deficit satisfying the transmission power deficit threshold, incrementing a high transmission power deficit count;
determining, for a monitoring window of a given number of transmission instances, a ratio of high transmission power deficit instances based on the high transmission power deficit count; and
responsive to the ratio of high transmission power deficit instances satisfying a ratio threshold, determining that the high transmission power deficit condition exists.

19. The method of claim 1,
wherein monitoring the plurality of layers of the communication stack of the UE device during the active voice call comprises monitoring at least one parameter across one or more of the plurality of layers of the communication stack, the at least one parameter associated with maintenance of the active voice call; and
wherein detecting the at least one adverse radio link condition associated with the active voice call comprises detecting the at least one adverse radio link condition associated with the active voice call based on the at least one parameter.

20. The method of claim 19,
wherein detecting the at least one adverse radio link condition associated with the active voice call based on the at least one parameter comprises detecting the at least one adverse radio link condition responsive to the at least one parameter satisfying a predetermined criteria.

21. A user equipment device, comprising:
one or more radio frequency (RF) modems configured to wirelessly communicate with at least one network;
one or more processors coupled to the one or more RF modems; and
at least one memory storing executable instructions, the executable instructions configured to manipulate at least one of the one or more processors or the one or more RF modems to:
monitor a plurality of layers of a communication stack of the UE device during an active voice call;
responsive to monitoring the plurality of layers, detect at least one adverse radio link condition associated with the active voice call; and
provide a radio link degradation (RLD) indication to a second component of the UE device in response to detecting the at least one adverse radio link condition.

22. (canceled)

23. A user equipment (UE) comprising:
a communication processor to detect at least one adverse radio link condition associated with an active voice call; and
an application processor to receive a radio link degradation indication in response to the communication processor detecting the at least one adverse radio link condition.
